(19) United States
(12) Patent Application Publication
(10) Pub. No.: US 2026/0178397 A1
(43) Pub. Date: Jun. 25, 2026

(54) Concurrency Management Model Using Software Transactional Memory, Dynamic Data Race Detection, And/Or Thread-Local Garbage Collection

(71) Applicant: Oracle International Corporation, Redwood Shores, CA (US)

(72) Inventor: Erik Österlund, Vasterhaninge (SE)

(73) Assignee: Oracle International Corporation, Redwood Shores, CA (US)

(21) Appl. No.: 19/225,600

(22) Filed: Jun. 2, 2025

Related U.S. Application Data
(60) Provisional application No. 63/738,717, filed on Dec. 24, 2024.

(51) Int. Cl. G06F 9/50; G06F 12/02

(52) U.S. Cl. CPC G06F 9/5027; G06F 12/0253; G06F 2212/7205

(57) ABSTRACT

Techniques for detecting and preventing potential sources of concurrency issues are disclosed. In response to an attempt to modify a shared data structure, the system generates a copy of the shared data structure in a transaction area allocated for performing the modification through a software memory transaction. The system applies the modification to the copy of the shared data structure, and the system subsequently acquires a lock on the shared data structure. After acquiring the lock, the system checks for accesses to the shared data structure that would conflict with applying the modification to shared data structure. If the check does not reveal a conflicting access, the system commits the software memory transaction by updating the shared data structure to match the state of the copy of the shared data structure. If the check does reveal a conflicting access, the system aborts the software memory transaction.

### BENEFIT CLAIMS; RELATED APPLICATIONS; INCORPORATION BY REFERENCE

This application claims the benefit of U.S. Provisional Patent Application No. 63/738,717, filed on Dec. 24, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to concurrent computing architectures. In particular, the present disclosure relates to techniques for avoiding potential concurrency issues.

### BACKGROUND

With respect to a computing architecture, the term “concurrency” refers to the ability of a computing system to perform multiple tasks simultaneously and/or the ability of the computing system to perform multiple tasks in overlapping time periods. The term “task” refers to a set of one or more related operations. Performing tasks concurrently can improve the efficiency and performance of a computing system. However, concurrency can also give rise to an issue that results from one task interfering with another task that is being performed concurrently (referred to herein as a “concurrency issue”). Many varieties of concurrency issues can result from data races. Example concurrency issues that may directly or indirectly result from a data race include nondeterministic behavior, memory corruption, livelock, deadlock, resource starvation, undefined program behavior, difficult to reproduce bugs, security risks, and other issues.

A data race may occur due to conflicting accesses to the same location in memory. For example, a data race may arise if (a) two or more threads of execution are concurrently performing tasks that involve accessing the same shared data structure and (b) at least one of those tasks is attempting to mutate the shared data structure. As used herein, the term “shared data structure” refers to a data structure that is accessible to multiple independent processes and/or subcomponents of processes. The verb “mutate” refers to changing the state of a data structure, and the noun “mutator” refers to a process and/or a subcomponent of that process that is attempting to mutate a data structure. A thread of execution that writes a new value to a data structure is an example of a mutator. The term “thread of execution” is used herein to identify a subcomponent of a process. For brevity, a thread of execution may be referred to herein simply as a “thread.” Two threads that access a shared data structure in a conflicting manner may be constituents of the same process, or those two threads may be constituents of two different processes.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example computing architecture in which techniques described herein may be practiced in accordance with one or more embodiments;

FIG. 2 is a block diagram illustrating a computer system suitable for implementing methods and features described herein in accordance with one or more embodiments;

FIG. 3 illustrates an example virtual machine memory layout in block diagram form in accordance with one or more embodiments;

FIG. 4 illustrates an example frame in block diagram form in accordance with one or more embodiments;

FIG. 5 illustrates a system for performing techniques described herein in accordance with one or more embodiments;

FIG. 6 illustrates an example set of operations for managing a software memory transaction in accordance with one or more embodiments;

FIG. 7 illustrates an example set of operations for lazily remapping stale pointers in accordance with one or more embodiments;

FIG. 8 illustrates an example set of operations for managing an attempt to read from a shared data structure outside of a software memory transaction in accordance with one or more embodiments;

FIG. 9 illustrates an example set of operations for managing example interactions with data structures in a concurrent computing environment in accordance with an example embodiment; and

FIG. 10 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.

1. GENERAL OVERVIEW
2. ARCHITECTURAL OVERVIEW
   2.1 EXAMPLE CLASS FILE STRUCTURE
   2.2 EXAMPLE VIRTUAL MACHINE ARCHITECTURE
   2.3 LOADING, LINKING, AND INITIALIZING
3. CONCURRENCY MANAGEMENT SYSTEM
4. MANAGING A TRANSACTION
5. LAZILY REMAPPING STALE POINTERS
6. READING FROM A SHARED DATA OUTSIDE OF A TRANSACTION
7. EXAMPLE EMBODIMENT
8. HARDWARE OVERVIEW
9. MISCELLANEOUS; EXTENSIONS

### 1. General Overview

One or more embodiments improve concurrency safety during program execution by combining software transactional memory, dynamic data race detection, and/or thread-local garbage collection. “Software transactional memory” refers to a concurrency control mechanism that compels at least some tasks to be performed through software memory transactions. In general, the system may compel tasks that pose a risk of creating a concurrency issue to be performed through software memory transactions. “Dynamic data race detection” refers to the practice of actively checking for existing or potential data races during program execution. While a software memory transaction is ongoing, the system dynamically checks for potential data races that may occur due to conflicts with a task that is being performed through the software memory transaction. “Thread-local garbage collection” refers to a garbage collection process that organizes private data structures of individual threads into local areas in runtime memory and performs independent garbage collection cycles within those local areas. Note that interactions with private data structures generally do not pose a risk of creating a data race. By distinguishing private data structures from shared data structures, the thread-local garbage collector reduces the cost of performing software memory transactions and dynamic data race detection.

One or more embodiments enforce a concurrency management model that combines software transactional memory, dynamic data race detection, and/or thread-local garbage collection. To ensure concurrency safety, the concurrency management model dictates that certain tasks are performed through software memory transactions and/or subjected to dynamic checks for potential sources of concurrency issues. For instance, the system may compel a program task that is attempting to mutate a shared data structure to be performed to a software memory transaction. As used herein, the term “program task” refers to a task that is performed at the behest of a program instance. During a software memory transaction, the system actively checks for potential sources of concurrency issues associated with shared data structures involved in the software memory transaction. For instance, prior to mutating a shared data structure through a software memory transaction, the system may check for another concurrent access to the shared data structure that may conflict with the mutation. If a dynamic check reveals a potential source of a concurrency issue associated with a shared data structure involved in a software memory transaction, the system may abort that software memory transaction. The system may allow some interactions with the shared data structures to occur outside of software memory transactions. For instance, if a program task is attempting to read from, but not write to, a shared data structure, the system may allow that program task to be performed outside of a software memory transaction.

One or more embodiments leverage a thread-local garbage collector to enforce a concurrency management model. The thread-local garbage collector organizes private data structures into private areas of runtime memory and shared data structures into a global area of runtime memory. In the context of a thread-local garbage collector, a “private data structure” refers to a data structure that is accessible to a program instance through a single thread. By clearly delineating shared data structures from private data structures, the thread-local garbage collector reduces the proportion of program tasks that need to be performed through software memory transactions and/or subjected to dynamic checks. As a result, the cost of enforcing the concurrency management model is reduced. The thread-local garbage collector may organize runtime memory through barriers that are imposed on the threads. A “barrier” is an additional set of instructions that is inserted into the instructions for completing a program instance. By inserting barriers into the instructions for completing a program instance, the thread-local garbage collector commandeers threads to perform garbage collection tasks during program execution. The system leverages the thread-local garbage collector to enforce the concurrency management model by including additional instructions within the barriers that are utilized by the thread-local garbage collector to manage runtime memory. The additional instructions included in the barriers may require threads to perform software memory transactions, dynamic data race detection, and/or other tasks that contribute to enforcing the concurrency management model. For instance, if a thread is attempting to perform a program task that would mutate a shared data structure, barriers imposed on the thread by the thread-local garbage collector may instruct the thread to perform this program task through a software memory transaction and/or perform dynamic data race detection.

One or more embodiments perform dynamic data race detection based on a partial ordering of events that have been observed by a thread leading up to a software memory transaction. A “partial ordering of events” refers to a relation among events where some pairs of events are ordered with respect to “happens-before” or causal dependency. Based on a partial ordering of events, the system may identify causally inconsistent accesses to the same shared data structure that result from a causality bug in a program instance. If accesses to the same shared data structure are causally inconsistent, those accesses may also conflict. If accesses to the same shared data structure conflict with another, those accesses may spawn data race. Thus, by dynamically checking for causally inconsistent accesses, the system may dynamically detect data races. Furthermore, causally inconsistent accesses may be indicative of a causality bug even if those accesses do not conflict, do not result in a data race, and/or do not lead to a concurrency issue. Therefore, by detecting causally inconsistent accesses, the system may identify a causality bug even if that causality bug does not presently pose a risk of creating a conflict, a data race, and/or a concurrency issue.

One or more embodiments prevent a program task that is being performed through a software memory transaction from directly interacting with data structures that are targeted by the program task. For instance, rather than directly manipulating data structures targeted by a program task that is being performed through a software memory transaction, the system creates clones of these data structures, and the system performs the program task on the clones. Interacting with data structures indirectly may prevent a concurrency issue, such as an infinite loop, which might otherwise be created if a shared data structure that is targeted by a program task is concurrently mutated while the program task is ongoing. While a program task is being performed through the software memory transaction, the system performs dynamic data race detection. If the system detects a potential source of a concurrency issue while a program task is being performed through the software memory transaction, the system may abort the software memory transaction. Note that if a software memory transaction is aborted before completing a program task on the clones that are created for the software memory transaction, there is no need to roll back any changes made by the program task because the instructions for completing the program task are applied to the clones rather than the actual data structures that are targeted by the program task. On the other hand, if a program task is successfully performed on the clones that are created for a software memory transaction, the system may (a) acquire locks on the shared data structures that are targeted by the program task and (b) perform additional dynamic checks for potential sources of concurrency issues while holding these locks; if these additional dynamic checks do not reveal any potential sources of concurrency issues, it may be assumed that committing a software memory transaction will not create a concurrency issue because holding the locks prevents another task from manipulating the shared data structures targeted by the program task. The system commits a software memory transaction through which a program task is performed by updating data structures targeted by the program task to match the state of the corresponding clones of those data structures to which the instructions for completing the program task have been applied.

One or more embodiments prevent a program task that is performed outside of a software memory transaction from directly interacting with shared data structures that are targeted by the program task. For instance, if a program task is attempting to read from, but not write to, a shared data structure, the system may create a clone of the shared data structure, and the thread may complete the program task by reading from the clone. If a program task attempts to write to a clone of a shared data structure outside of a software memory transaction, the system may block that program task. The system may perform dynamic data race detection while indirectly interacting with shared data structures outside of a software memory transaction. For instance, before reading from a clone of a shared data structure outside of a software memory transaction, the system may check for potential sources of concurrency issues associated with the read operation. Alternatively, the system may read from a clone of a shared data structure outside of a software memory transaction with performing a check for potential sources of concurrency issues. Whether or not the system performs dynamic data race detection while indirectly interacting with shared data structures outside of a transaction may depend on how the system attributes the blame for a conflict between a read operation and a write operation; in some embodiments, the blame is attributed to the reader, and, in other embodiments, the blame is attributed to the writer.

One or more embodiments enforce a concurrency management model that attributes the blame for a potential conflict between a write to a shared data structure and a read from that same shared data structure on the writer rather than the reader. To this end, the system may track indirect interactions with shared data structures that occur outside of software memory transactions. When a thread attempts to read from a shared data structure outside of a software memory transaction at the behest of a program instance, the system directs the thread to create a clone of the shared data structure and increment a read counter of the shared data structure. At the outset of a software memory transaction that will be performed by a thread, the system directs the thread to discard any clones of shared data structures that have been created by the thread outside of the software memory transaction and decrement the corresponding read counters accordingly. While a thread is attempting to perform a program task through a software memory transaction, the system may direct the thread to check a read counter of a shared data structure that is targeted by the program task. If a thread, performing a program task through a software memory transaction, finds that a read counter of a shared data structure targeted by the program task is greater than zero, it may be presumed that another thread is concurrently reading from a clone of the shared data structure. If another thread is reading from a clone of a shared data structure while a thread is concurrently attempting to mutate that shared data structure through a software memory transaction, the system places the blame for this potential conflict on the writer rather than the reader by aborting the software memory transaction instead of blocking and/or delaying the program task that is presumed to be concurrently reading from the clone of the shared data structure.

One or more embodiments described in this Specification and/or recited in the claims may not be included in this General Overview section.

### 2. Architectural Overview

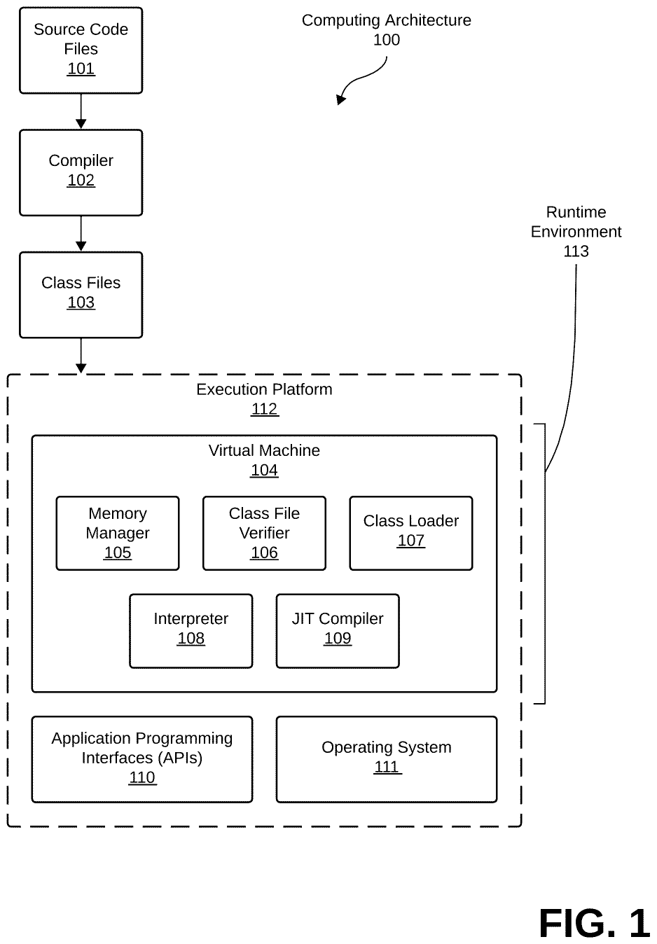

FIG. 1 illustrates an example architecture in which techniques described herein may be practiced. Software and/or hardware components described with relation to the example architecture may be omitted or associated with a different set of functionality than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 which are compiled by a compiler 102 into class files 103 representing the program to be executed. The class files 103 are then loaded and executed by an execution platform 112, which includes a runtime environment 113, an operating system 111, and one or more application programming interfaces (APIs) 110 that enable communication between the runtime environment 113 and the operating system 111. The runtime environment 113 includes a virtual machine 104 comprising various components, such as a memory manager 105 (which may include a garbage collector), a class file verifier 106 to check the validity of class files 103, a class loader 107 to locate and build in-memory representations of classes, an interpreter 108 for executing the virtual machine 104 code, and a just-in-time (JIT) compiler 109 for producing optimized machine-level code.

In an embodiment, the computing architecture 100 includes source code files 101 that include code that has been written in a particular programming language, such as Java, C, C++, C#, Ruby, Perl, etc. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification to which the source code files 101 adhere. The exact programming language used to write the source code files 101 is generally not critical.

In various embodiments, the compiler 102 converts the source code, which is written according to a specification directed to the convenience of the programmer, to either machine or object code, which is executable directly by the particular machine environment, or an intermediate representation (“virtual machine code/instructions”), such as bytecode, which is executable by a virtual machine 104 that is capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware on which the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent run-time performance. In addition, since the transformation occurs globally before execution, the code can be analyzed and optimized using techniques such as constant folding, dead code elimination, inlining, etc. However, depending on the program being executed, the startup time can be significant. In addition, inserting new code would require the program to be taken offline, re-compiled, and re-executed. For many dynamic languages (such as Java) which are designed to allow code to be inserted during the program's execution, a purely compiled approach may be inappropriate. When a program is interpreted, the code of the program is read line-by-line and converted to machine-level instructions while the program is executing. As a result, the program has a short startup time (can begin executing almost immediately), but the run-time performance is diminished by performing the transformation at runtime. Furthermore, since various instructions are analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions which replaces the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting instructions individually. There are several variations on the above described example, such as tiered compiling.

In order to provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format to which the class files 103 are expected to adhere. In some embodiments, the class files 103 contain the virtual machine instructions that have been converted from the source code files 101. However, in other embodiments, the class files 103 may contain other structures as well, such as tables identifying constant values and/or metadata related to various structures (classes, fields, methods, etc.).

The following discussion assumes that the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages”, each of which includes a collection of classes that provide related functionality. For example, a library may contain one or more class files that implement input/output (I/O) operations, mathematics tools, cryptographic techniques, graphics utilities, etc. Further, some classes (or fields/methods within those classes) may include access restrictions that limit their use to within a particular class/library/package or to classes with appropriate permissions.

### 2.1 Example Class File Structure

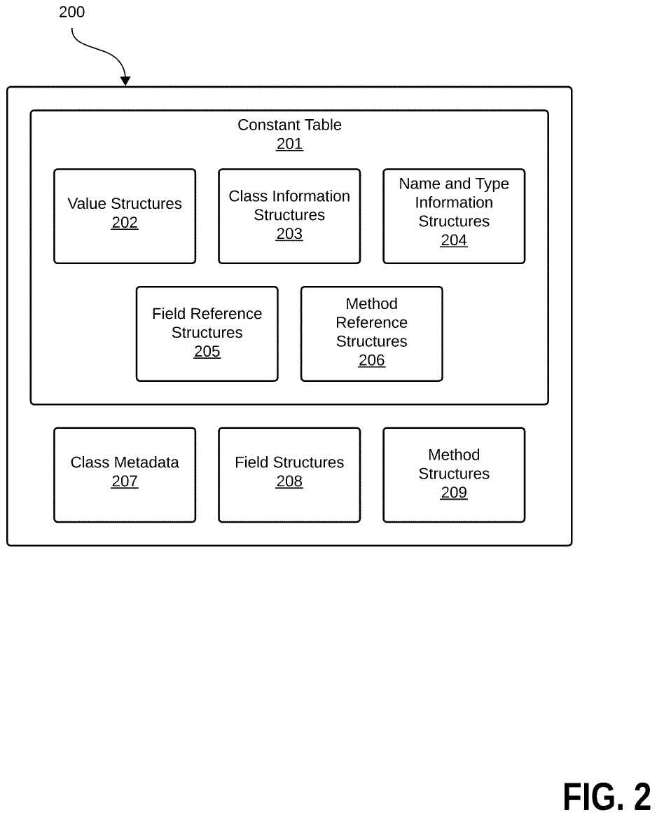

FIG. 2 illustrates an example structure for a class file 200 in block diagram form according to an embodiment. In order to provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, class metadata 207, field structures 208, and method structures 209. In an embodiment, the constant table 201 is a data structure which, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, etc.), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures which index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (if the class is public, private, final, abstract, etc.), an index to one of the class information structures 203 of the constant table 201 that identifies the present class, an index to one of the class information structures 203 of the constant table 201 that identifies the superclass (if any), etc.

In an embodiment, the field structures 208 represent a set of structures that identifies the various fields of the class. The field structures 208 store, for a field of the class, accessor flags for the field (if the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for a method of the class, accessor flags for the method (e.g. if the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”=byte, “C”=char, “D”=double, “F”=float, “I”=int, “J”=long int, etc.). When a field holds an object, the descriptor is a string that identifies the class name of the object (e.g., “L ClassName”). “L” in this case indicates a reference; thus, “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[[L ClassName” indicates an array where an index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m (int I, double d, Thread t) { . . . }” matches the descriptor “(I D L Thread) L Object”.

In an embodiment, the virtual machine instructions held in the method structures 209 include operations which reference entries of the constant table 201. Using Java as an example, consider the following class:
class A
{
   int add12and13( ) {
      return B.addTwo(12, 13);
   }
}

In the above example, the Java method add12and13 is defined in class A, takes no parameters, and returns an integer. The body of method add12 and13 calls static method addTwo of class B which takes the constant integer values 12 and 13 as parameters, and returns the result. Thus, in the constant table 201, the compiler 102 includes, among other entries, a method reference structure that corresponds to the call to the method B.addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(I I) I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the run-time representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

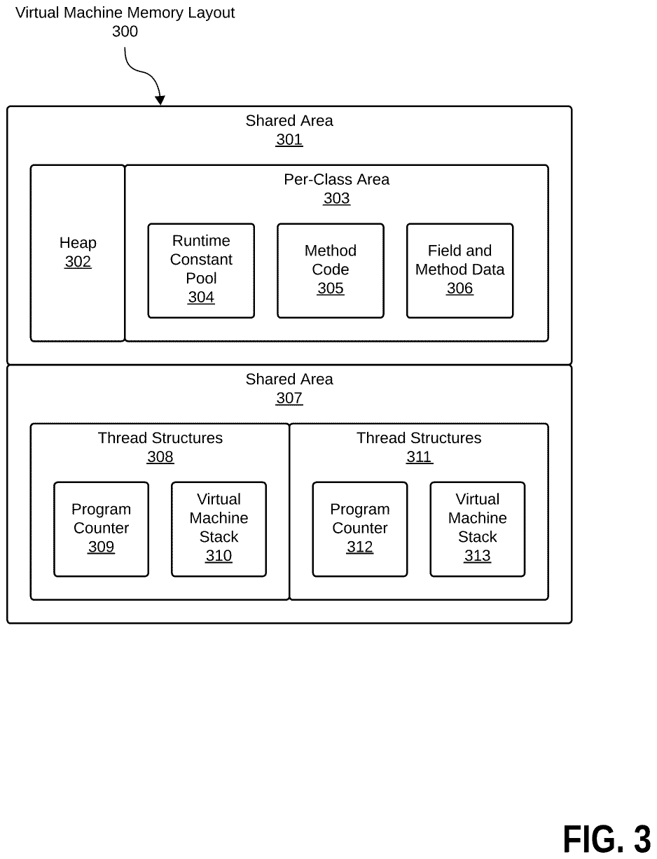

FIG. 3 illustrates an example virtual machine memory layout 300 in block diagram form according to an embodiment. In order to provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas are contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the run-time data area from which memory for class instances and arrays is allocated. In an embodiment, the per-class area 303 represents the memory area where the data pertaining to the individual classes are stored. In an embodiment, the per-class area 303 includes, for a loaded class, a run-time constant pool 304 representing data from the constant table 201 of the class, field and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. In order to provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class to which the current method belongs is referred to as the current class.

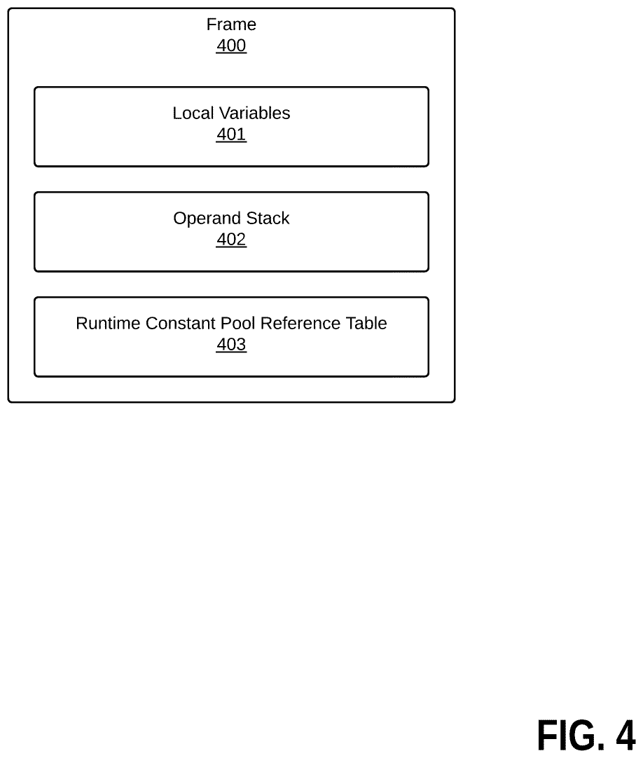

FIG. 4 illustrates an example frame 400 in block diagram form according to an embodiment. In order to provide clear examples, the remaining discussion will assume that frames of virtual machine stack 310 and virtual machine stack 313 adhere to the structure of frame 400.

In an embodiment, frame 400 includes local variables 401, operand stack 402, and run-time constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, when the frame 400 is created by the virtual machine 104, the operand stack 402 is empty by default. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the run-time constant pool reference table 403 contains a reference to the run-time constant pool 304 of the current class. The run-time constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the run-time location of these variables.

### 2.3 Loading, Linking, and Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the representation from the associated class file 200 may include creating the run-time constant pool 304, method code 305, and field and method data 306 for the class within the per-class area 303 of the virtual machine memory layout 300. Linking is the process of taking the in-memory representation of the class and combining it with the run-time state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in many embodiments the steps may be interleaved, such that an initial class is loaded, then during linking a second class is loaded to resolve a symbolic reference found in the first class, which in turn causes a third class to be loaded, etc. Thus, progress through the stages of loading, linking, and initializing can differ from class to class. Furthermore, some embodiments may delay (perform “lazily”) one or more functions of the loading, linking, and initializing process until the class is required. For example, resolution of a method reference may be delayed until a virtual machine instruction invoking the method is executed. Thus, the exact timing of when the steps are performed for each class can vary greatly between implementations.

To begin the loading process, the virtual machine 104 invokes the class loader 107 which loads an initial class. The technique by which the initial class is specified will vary from embodiment to embodiment. For example, one technique may have the virtual machine 104 accept a command line argument on startup that specifies the initial class.

To load a class, the class loader 107 parses the class file 200 corresponding to the class and determines if the class file 200 is well-formed (meets the syntactic expectations of the virtual machine 104). If not, the class loader 107 generates an error. For example, in Java the error might be generated in the form of an exception which is thrown to an exception handler for processing. Otherwise, the class loader 107 generates the in-memory representation of the class by allocating the run-time constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking and initializing process for the particular class.

During linking, the virtual machine 104 verifies the class, prepares the class, and resolves the symbolic references defined in the run-time constant pool 304 of the class.

To verify the class, the virtual machine 104 checks if the in-memory representation of the class is structurally correct. For example, the virtual machine 104 may check that each class except the generic class Object has a superclass, check that final classes have no sub-classes and final methods are not overridden, check if constant pool entries are consistent with one another, check if the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), etc. The exact checks performed during verification are dependent on the implementation of the virtual machine 104. In some cases, verification may cause additional classes to be loaded, but does not necessarily require those classes to also be linked before proceeding. For example, assume Class A contains a reference to a static field of Class B. During verification, the virtual machine 104 may check Class B to ensure that the referenced static field actually exists, which might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the run-time constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking if the field/method is defined in the referenced class. Otherwise, the virtual machine 104 recursively searches through the super-classes of the referenced class for the referenced field/method until the field/method is located, or the top-level superclass is reached, in which case an error is generated.

### 3. Concurrency Management System

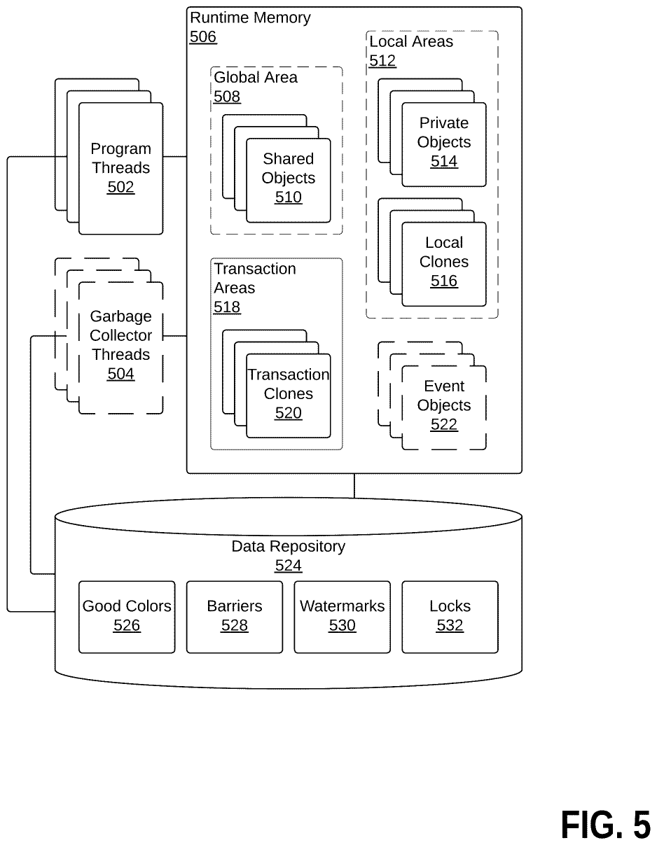

FIG. 5 illustrates a system 500 for performing techniques described herein in accordance with one or more embodiments. As illustrated in FIG. 5, system 500 may include program threads 502, garbage collector threads 504, runtime memory 506, and data repository 524. In one or more embodiments, the system 500 may include more or fewer components than the components illustrated in FIG. 5. The components illustrated in FIG. 5 may be local to or remote from each other. The components illustrated in FIG. 5 may be implemented in software and/or hardware. Each component may be distributed over multiple applications and/or machines. Multiple components may be combined into one application and/or machine. Operations described with respect to one component may instead be performed by another component.

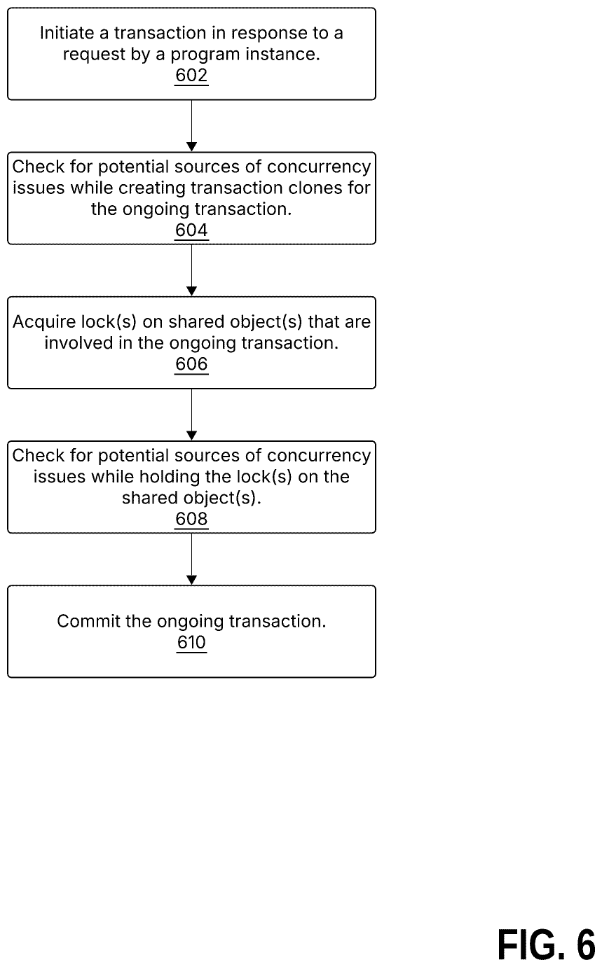

In one or more embodiments, system 500 refers to software and/or hardware for implementing a concurrency management model. Depending on the embodiment, the concurrency management model may combine software transactional memory techniques, dynamic data race detection, and/or thread-local garbage collection. The concurrency management model may require certain program tasks to be performed through software memory transactions. For brevity, a software memory transaction may be referred to herein simply as a “transaction.” Example operations for managing a transaction are described below with reference to FIG. 6. The program tasks that are performed through transactions may vary depending on the runtime environment, the programming languages in play, the manner that memory space allocated for runtime memory is reclaimed, and various other factors. Furthermore, the program tasks that are performed through transactions may be configured by a user of system 500.

In an embodiment, system 500 is configured to initiate transactions in response to specific tokens that may be used to define a program task in the source code of a program. For example, system 500 may be configured to initiate a transaction in response to certain keywords, such as atomic keywords, transaction keywords, synchronized keywords, volatile keywords, final keywords, or others. Additionally, or alternatively, a user of system 500 may designate certain tokens that can be used to define a program task that should not be performed through a transaction. For example, a developer of a program may be provided with a specific keyword that can be used to define a program task that reads from and/or writes to a shared data structure outside of a transaction.

In an embodiment, system 500 is a computing environment that includes multiple threads of executions. A thread of execution, such as a program thread 502 or a garbage collector thread 504, is an independent execution environment for machine-level instructions. A multi-thread computing environment is an example of a computing environment that can perform concurrent operations. A typical implementation of the Java Runtime Environment is one example of a multi-thread computing environment. The implementation of system 500 as a threaded computing environment is described herein for illustrative purposes and is not intended to define any limits to this disclosure. A threaded computing environment is neither essential nor necessary to practice the techniques described herein. The techniques described herein are equally applicable to other computing architectures. In general, the techniques described herein are applicable to any computing architecture that can perform concurrent computing operations. The techniques described herein are applicable to both centralized computing systems and distributed computing systems.

In an embodiment, a program thread 502 refers to a thread of execution that is generally allocated for performing tasks at the behest of a program instance. In other words, a program thread 502 is a thread that performs program tasks. Note that completing some program tasks may require manipulating information residing in runtime memory 506. For instance, while completing the requests of a program instance, a program thread 502 may be creating new data structures within runtime memory 506, reading from data structures residing in runtime memory 506, writing to data structures residing in runtime memory 506, and/or performing various other operations within runtime memory 506.

In an embodiment, a program thread 502 is configured to track an ordering of events that are observed by the program thread 502 during runtime. A program thread 502 may be configured to track a partial ordering of events or a total ordering of events. In an example, a program thread 502 is configured to track a partial ordering of synchronization events that are observed by the program thread 502 during program execution. Example mechanisms that may be utilized by a program thread 502 to track an ordering of events include an object graph of events, vector clocks, Lamport's timestamps, timestamps, and other mechanisms.

In an embodiment, a garbage collector thread 504 refers to a thread of execution that is generally allocated for performing tasks at the behest of a garbage collection process. As used herein, the term “garbage collection” refers generally to memory management. In the example context of system 500, a garbage collection process may be configured to reclaim memory allocated to data structures residing within runtime memory 506 that are no longer needed by a currently executing program instance. In some embodiments, system 500 excludes dedicated garbage collector threads 504 because garbage collection tasks are delegated to program threads 502. In other words, there may be no distinction between a program thread 502 and a garbage collector thread 504 in some embodiments.

In an embodiment, runtime memory 506 refers to a data repository that includes memory space allocated for the use of one or more program instances during runtime. In addition to including information that can be manipulated by a program thread 502 at the behest of a program instance, runtime memory 506 may include information that is not exposed at a program-level. Runtime memory 506 may be implemented on any type of storage unit and/or device (e.g., a file system, database, collection of tables, or any other storage mechanism) for storing data. Furthermore, runtime memory 506 may be implemented on multiple different storage units and/or devices. The multiple different storage units and/or devices may or may not be of the same type or located at the same physical site. Runtime memory 506 may be implemented in volatile memory, and/or runtime memory 506 may be implemented in non-volatile memory.

In an embodiment, runtime memory 506 is implemented in the context of one or more class-based, object-oriented programming languages. Examples of class-based, object-oriented programming languages include Java, C++, C#, Python, Ruby, and others. The implementation of runtime memory 506 in the context of class-based, object-oriented program language(s) is described herein for illustrative purposes and is not intended to define any limits to the disclosure. A class-based, object-oriented programming language is neither essential nor necessary to practice the techniques described herein. The techniques described herein are equally applicable to other data structures, other computing environments, and other programming languages.

In an embodiment, information is represented within runtime memory 506 by runtime objects. A runtime object is a data structure that exists in memory during program execution (i.e., runtime). An example runtime object is an instance of a reference type such as a class. A runtime object may be conceptualized as a higher-level abstraction of binary data that resides somewhere in low-level memory. For example, a runtime object may be an abstraction of binary data stored to main memory (e.g., random access memory (RAM)). In the example illustrated by FIG. 3, runtime memory 506 may be implemented, in whole or in part, within heap 302. In this example, runtime memory 506 will typically include various other runtime objects that are not represented in FIG. 5.

In an embodiment, runtime memory 506 is subjected to a garbage collection process during runtime. For instance, an example garbage collection process is configured to reclaim memory space allocated to runtime objects residing in runtime memory 506. The example garbage collection process deems memory space allocated to a runtime object eligible for reclamation if that runtime object has become less than strongly reachable. A runtime object is strongly reachable if there is a chain of strong reference(s) that can be traversed by at least one program thread 502 to access that runtime object. The term “strong reference” refers to a reference that (a) participates fully in a reachability analysis that is performed by a garbage collector and (b) is not subjected to the collection rules that are applied to specialized references, such as soft references, weak references, phantom references, and so on. If there is no chain of strong reference(s) that can be traversed by a program thread 502 to access a runtime object at the behest of a program instance, that runtime object is not strongly reachable. Note that a runtime object being less than strongly reachable to a program thread 502 does not necessarily imply that the runtime object is unreachable to that program thread 502. For example, a runtime object that is not strongly reachable may remain reachable through a non-strong reference. Furthermore, the term “unreachable” is not necessarily synonymous with the term “inaccessible.” For example, a runtime object that is unreachable to a program thread 502 may remain accessible to a garbage collector thread 504. As used herein, the term “disposable” identifies information that is eligible for garbage collection, and the term “live” identifies information that is ineligible for garbage collection. In other embodiments, runtime memory 506 is not subjected to a separate garbage collection process during runtime. For example, in these other embodiments, disposable information may be deallocated by a program instance.

In an embodiment, runtime memory 506 is subjected to a thread-local garbage collection process. An example thread-local garbage collector organizes private objects 514 of program threads 502 into local areas 512 and performs independent garbage collection cycles in those local areas 512. As noted above, interactions with private objects 514 generally do not pose a risk of creating data races because a program instance is unable to interact with a private object 514 through more than one thread. Therefore, there may be no need for an interaction with a private object 514 to be performed through a transaction or subjected to a dynamic data race detection, and, to do so, might exact a needless cost on program performance. In contrast to private objects 514, the example thread-local garbage collector organizes shared objects 510 into a global area 508. By organizing shared objects 510 and private objects 514 in this manner, the example thread-local garbage collector clearly delineates shared objects 510 from private objects 514. In this way, the thread-local garbage collector allows program tasks that should be performed through transactions and/or subjected to dynamic data race detection to be readily differentiated from other program tasks that need not be subjected to these mechanisms for ensuring concurrency safety. As a result, the cost of performing software memory transactions and dynamic data race detection is reduced because these concurrency safety mechanisms are not overzealously applied to program tasks that pose no risk or a minimal risk of creating a concurrency issue. Note that the dynamic checks that are performed by the system 500 may identify potential sources of concurrency issues other than data races. Thus, the dynamic checks that are performed by system 500 may be referred to herein more generally as “checks for potential sources of concurrency issues.” It should also be noted that, in other embodiments, runtime memory 506 is subjected to other types of garbage collection processes. A thread-local garbage collection process is neither essential nor necessary to practice techniques described herein.

In an embodiment, global area 508 refers to a portion of runtime memory 506 that is generally allocated for storing information that is accessible to multiple program threads 502. In other words, the global area 508 is generally used for storing shared information. Global area 508 may be implemented in volatile memory, and/or global area 508 may be implemented in non-volatile memory. As illustrated in FIG. 5, information stored to global area 508 may include shared objects 510.

In an embodiment, a shared object 510 refers to a runtime object that a program instance can interact with through multiple program threads 502. Generally, there are multiple program threads 502 that can obtain a traversable reference to a shared object 510 while executing a program task. While actively performing a program task, a program thread 502 is typically able to obtain a reference to a runtime object if that runtime object is reachable to the program thread 502. However, note that some references, such as phantom references, cannot be traversed by a program thread 502 while actively executing a program instance 502. Thus, some forms of “reachability,” such as phantom reachability, do not necessarily coincide with accessibility. As noted above, multiple conflicting accesses to a shared object 510 may give rise to a concurrency issue. For example, two accesses to a shared object 510 conflict if (a) those two accesses are performed in furtherance of two separate tasks that are being performed concurrently and (b) at least one of those tasks is attempting to mutate the shared object 510. If the two conflicting accesses are allowed to occur in this example, a data race may occur, and that data race may result in a concurrency issue. However, note that conflicting accesses do not necessarily result in a data race. It should also be noted that, in some cases, two accesses to a shared object 510 may conflict even if both of those two accesses are reading from the shared object 510 and not writing to the shared object 510.

In an embodiment, a shared object 510 is generally immutable outside of a transaction. In other words, the system 500 will generally require a mutation to a shared object 510 to be performed through a transaction. However, a user of system 500 may be permitted to bypass this requirement. For example, a developer may be provided with a keyword or other mechanism that allows the developer to define a program task that will be able to mutate a shared object 510 outside of a transaction. The ability to bypass a general prohibition on mutating shared objects 510 outside of a transaction may be desirable in applications where even minor improvements in program performance outweigh the additional concurrency safety that is obtained by compelling mutations to shared objects 510 to be performed through transactions.

In an embodiment, a shared object 510 may possess a read counter that corresponds to reads from the shared object 510. For example, a read counter of a shared object 510 may track the number of local clones of the shared object 510 that are presently reachable to a program thread 502. A read counter stored to a shared object 510 may or may not be exposed at a program level. A read counter of shared object 510 may be stored to the shared object 510 and/or other locations in memory.

In an embodiment, system 500 may prohibit a program thread 502 from manipulating a shared object 510 while executing the instructions for completing a program task. As a result, a program instance that is being performed by a program thread 502 may be prevented from directly interacting with a shared object 510. In this embodiment, a program thread 502 is permitted to manipulate shared objects 510 while executing a barrier 528. A barrier 528 that instructs a program thread 502 to manipulate a shared object 510 may be imposed on the program thread 502 in response to an operation that is requested by a program instance. In this way, a program instance can indirectly interact with a shared object 510. By limiting a program instance to indirectly accessing shared objects 510, concurrency safety may be improved. Furthermore, note that limiting a program instance to indirectly accessing shared objects 510 may reduce the amount of volatile memory that is allocated for runtime memory of the program instance. To improve the performance of a program instance, information that is directly accessible to the program instance is often stored in a manner that facilitates quick access. For instance, information that is directly accessible to a program instance is often stored in main memory, stored in an uncompressed format, and/or stored in a manner that may result in data duplication. However, if shared objects 510 are not directly accessible to a program instance, it may be unnecessary to prioritize quick access over memory density with respect to how the shared objects 510 are stored.

In an embodiment, shared objects 510 are stored in non-volatile memory. For example, rather than being stored in a computing system's main memory (e.g., random access memory), shared objects 510 may be stored in a non-volatile storage medium of the computing system (e.g., a hard disk drive, a solid-state drive, etc.). Additionally, or alternatively, shared objects 510 may be stored in a format that is optimized for storage density. For example, information describing shared objects 510 may be subjected to compression, deduplication, and/or other techniques for increasing storage density. Note that storing shared objects outside of volatile memory, in a compressed format, and/or in a manner that eliminates data duplication may significantly decrease the amount of volatile memory that is allocated for runtime memory of a program instance.

In an embodiment, a local area 512 refers to a portion of runtime memory 506 that is generally allocated for the private runtime memory of a specific program thread 502. For example, a local area 512 of a program thread 502 may include information that is inaccessible to other program threads 502 while those program threads 502 are actively performing program tasks. As illustrated in FIG. 5, a local area 512 may include private objects 514 and local clones 516.

In an embodiment, a private object 514 refers to a runtime object that (a) a program instance can interact with through a single program thread 502 and (b) is not a local clone 516. In other words, if a runtime object is a private object 514, there is a single program thread 502 that can access that runtime object at the behest of a program instance; no other program thread 502 can obtain a traversable reference to that runtime object while performing a program task. As noted above, some forms of “reachability” do not coincide with accessibility. Thus, a runtime object that is reachable to multiple program threads 502 may nonetheless be a private object 514.

Note that the use of the word “private” as an adjective in the term “private object” does not refer to a private accessor flag. A private object 514 does not necessarily include a private field. In many cases, a private object 514 includes no private fields.

In an embodiment, a private object 514 may become a shared object 510. Generally, a shared object 510 is initially a private object 514. As an example, consider two runtime objects, object A and object B. At the start of this example, object A is shared object 510, and object B is a private object 514. If a strong reference to object B is stored in object A in this example, object B also becomes a shared object 510. For the purposes of this example, further assume that object B strongly refers to another private object 514 at the start of this example, object C. If object B becomes a shared object 510 while retaining the strong reference to object C, object C will also become a shared object 510 in this example. It should also be noted that a shared object 510 may revert to being a private object 514.

In an embodiment, a local clone 516 refers to a copy of a shared object 510 that is created for the personal use of a program thread 502. An example local clone 516 is a read-only object. In other words, a program thread 502 can read from the local clone 516, but the program thread 502 cannot write to the local clone 516. The example local clone 516 is unreachable to other program threads 502, or the example local clone 516 is reachable to other program threads 502.

In an embodiment, a transaction area 518 refers to a portion of runtime memory 506 that is allocated for performing a program task through a transaction. Memory space for a transaction area 518 is allocated at the outset of a transaction, and/or memory space for a transaction area 518 is allocated piecemeal during the transaction. As illustrated in FIG. 5, a transaction area 518 may include transaction clones 520.

In an embodiment, a transaction clone 520 refers to a copy of a runtime object targeted by a program task that is being performed through a transaction. A program task is said to “target” a runtime object if the instructions for completing the program task reference the runtime object. For example, a program task targets a runtime object if the instructions for completing the program task direct a program thread 502 to read from and/or write to that runtime object. If a runtime object is targeted by a program task that is being performed through a transaction, that runtime object may also be referred to herein as being “involved in” the transaction. A transaction clone 520 may be a copy of any type of runtime object that is involved in a transaction. An example transaction clone 520 is a copy of a shared object 510, or the example transaction clone 520 is a copy of a private object 514.

In an embodiment, an event object 522 refers to a runtime object that serves as a record of an event that is observed by a program thread 502. For example, an event object 522 may be a record of a transaction that is attempted by a program thread 502. An event object 522 that represents one event may include a reference to another event object 522 representing another event that occurred most recently before or after the one event. In this way, event objects 522 and the references between the event objects 522 may form an object graph that tracks an ordering of events. In an example, an object graph of events that is made up of event objects 522 and references between the event objects 522 represents a partial ordering of events that are observed by a program thread 502 during runtime.

In one or more embodiments, a data repository 524 is any type of storage unit and/or device (e.g., a file system, database, collection of tables, or any other storage mechanism) for storing data. Furthermore, a data repository 524 may include multiple different storage units and/or devices. The multiple different storage units and/or devices may or may not be of the same type or located at the same physical site. Furthermore, a data repository 524 may be implemented or executed on the same computing system as other components of system 500. Additionally, or alternatively, a data repository 524 may be implemented or executed on a computing system separate from other components of system 500. The data repository 524 may be communicatively coupled to other components of system 500 via a direct connection or via a network. As illustrated in FIG. 5, data repository 524 may include good colors 526, barriers 528, watermarks 530, and locks 532. Information describing good colors 526, barriers 528, watermarks 530, and locks 532 may be implemented across any of the components within the system 500. However, this information is illustrated within the data repository 524 for purposes of clarity and explanation.

In an embodiment, a good color 526 is a value that is used for coloring pointers. As used herein, the term “pointer” refers to a set of bits that includes an address of a location in memory, and the phrase “coloring a pointer” refers to embedding metadata into bit(s) within a pointer that are not being used for storing an address of a location in memory. A pointer may be used to implement a reference (e.g., a reference to a runtime object), and the presence or absence of a good color 526 in the pointer may indicate the state of the reference, the state of a data structure that is identified by the reference, and/or the state of a data structure that includes the reference. A record of a value that is presently considered a good color 526 may be stored to a location in memory that is readily accessible to threads. For instance, good colors 526 may be stored to global variables, stored to thread-local variables, encoded into barriers 528, and/or maintained in any other location that is readily accessible to a program thread 502 and/or a garbage collector thread 504. Note that a value that is considered to be a good color 526 may change. Any value that is not presently considered a good color 526 is referred to as a “bad color”

In an embodiment, a barrier 528 refers to an additional set of instructions that is inserted into the instructions for completing a task. For example, while converting class files 103 of a program into machine-level code, JIT compiler 109 may insert a barrier 528 into the machine-level instructions that correspond to the program tasks that are to be performed by a program thread 502. A barrier 528 is referred to herein as being “imposed” on a thread when the thread is actively performing the instructions defined in the barrier 528. Barriers 528 may be imposed on program threads 502, and/or barriers 528 may be imposed on garbage collector threads 504. By imposing a barrier 528 on a program thread 502 that is completing requests of a program instance (i.e., program tasks), system 500 may compel that program thread 502 to perform operations other than the operations that are requested by the program instance. Example barriers 528 that may be imposed on a thread by system 500 include load barriers, store barriers, initiation barriers, commit barriers, and other barriers. Barriers 528 may be imposed on a thread during a transaction, and/or barriers 528 may be imposed on a thread outside of a transaction. As used herein, the term “transactional barrier” refers to a barrier 528 that is imposed on a thread during a transaction, and the term “non-transactional barrier” refers to a barrier 528 that is imposed on a thread outside of a transaction.

In an embodiment, a barrier 528 imposed on a program thread 502 directs the program thread 502 to perform operations that facilitate a garbage collection process that is occurring in runtime memory 506 (referred to herein as “garbage collection operations”). For example, a barrier 528 that is imposed on a program thread 502 may direct the program thread 502 to perform garbage collection operations that further a garbage collection cycle that is targeting a local area 512 of the program thread 502. Additionally, or alternatively, a barrier 528 imposed on a program thread 502 may direct the program thread 502 to perform operations that facilitate the completion of a transaction in runtime memory 506. For example, a barrier 528 that instructs a program thread 502 to perform garbage collection operations in furtherance of a thread-local garbage collection process may also direct the program thread 502 to perform operations that facilitate the completion of transactions in runtime memory 506.

In an embodiment, a barrier 528 is a load barrier. A load barrier is a barrier 528 that is imposed on a thread in response to the thread being instructed to perform a load operation. An example load operation is a request by a program instance for a program thread 502 to load a reference to a runtime object. An example load barrier specifies operations that a program thread 502 may be directed to perform before and/or after a load operation that triggers the imposition of the example load barrier. Load barriers may be imposed on a thread during a transaction, and/or load barriers may be imposed on the thread outside of a transaction. As used herein, the term “transactional load barrier” refers to a load barrier that is imposed on a thread during a transaction, and the term “non-transactional load barrier” refers to a load barrier that is imposed on a thread outside of a transaction.

In an embodiment, a barrier 528 is a store barrier. A store barrier is a barrier 528 that is imposed on a thread in response to the thread being instructed to perform a store operation. An example store operation is a request by a program instance for a program thread 502 to store a value to a location in memory such as an object field of a runtime object. An example store barrier specifies operations that a program thread 502 may be required to perform before and/or after a store operation. Store barriers may be imposed on a thread during a transaction, and/or load barriers may be imposed on the thread outside of a transaction. As used herein, the term “transactional store barrier” refers to a store barrier that is imposed on a thread during a transaction, and the term “non-transactional store barrier” refers to a store barrier that is imposed on a thread outside of a transaction.

In an embodiment, a barrier 528 is an initiation barrier. As used herein, the term “initiation barrier” refers to a barrier 528 that defines operations for initiating a transaction. An example initiation barrier is imposed on a program thread 502 in response to a program instance directing the program thread 502 to perform a program task that triggers a transaction. The example initiation barrier directs the program thread 502 to prepare for completing the program task through the transaction. Example operations that may be performed by the program thread 502 while executing the example initiation barrier include (a) allocating a transaction area for the transaction, (b) creating a record of the transaction, (c) updating a record of the most recent event that has been observed by the program thread 502, (d) updating a record of a most recent transaction to occur in runtime memory 506, (e) discarding local clones 516 of shared objects 510 that reside in the program thread's 502 local area 512 of runtime memory 506, (f) updating read counters of shared objects 510, (g) performing garbage collection tasks, and/or (h) other operations.

In an embodiment, a barrier 528 is a transactional load barrier. An example transactional load barrier is imposed on a program thread 502 in response to a load operation that is defined in the instructions for completing a program task that is being performed through a transaction. The load operation that triggers the imposition of the example transactional load barrier may be targeting a shared object 510 or a private object 514. The example transactional load barrier may direct the program thread 502 to perform a check for potential sources of concurrency issues associated with accessing the runtime object that is targeted by the load operation. For instance, if the runtime object that is targeted by the load operation is a shared object 510, the example transactional load barrier may direct the program thread 502 to check for other accesses to the shared object 510 by other threads that potentially conflict with an attempt by the program thread 502 to read from and/or write to the shared object 510. Additionally, or alternatively, the example transactional load barrier may direct the program thread 502 to create a transaction clone 520 of the runtime object that is targeted by the load operation. Rather than allowing the program task to directly manipulate the runtime object that is targeted by the load operation, the example transactional load barrier may direct the program thread 502 to manipulate the transaction clone 520 of that runtime object. Additionally, or alternatively, the example transactional load barrier may require the program thread 502 to perform garbage collection operations.

In an embodiment, a barrier 528 is a transactional store barrier. An example transactional store barrier is imposed on a program thread 502 in response to a store operation that is defined in the instructions for completing a program task that is being performed through a transaction. If the store operation is targeting a runtime object, the example transactional store barrier may direct the program thread 502 to perform a check for potential sources of concurrency issues associated with the runtime object that is targeted by the store operation. Additionally, or alternatively, the example transactional store barrier may direct the program thread 502 to determine if storing the value to the runtime object would result in any other private objects 514 being rendered into shared objects 510. For instance, if the store operation is attempting to store a reference to a private object 514 within a shared object 510, the transactional store barrier may direct the program thread 502 to flag that private object 514 for promotion when the transaction is committed. Rather than allowing the program thread 502 to store the value directly to the runtime object that is targeted by the store operation, the example transactional store barrier may direct the program thread 502 to store the value to a transaction clone 520 of that runtime object. Additionally, or alternatively, the example transactional store barrier may require the program thread 502 to perform garbage collection operations.

In an embodiment, a barrier 528 is a commit barrier. As used herein, the term “commit barrier” refers to a barrier 528 that defines operations for committing a transaction. An example commit barrier 528 is imposed on a program thread 502 after the program thread 502 has performed the instructions for completing a program task on transaction clones 520 of the runtime objects that are targeted by the program task. Example operations that may be performed by the program thread 502 while executing the example commit barrier include (a) acquiring locks 532 on shared objects 510 involved in the transaction, (b) checking for potential sources of concurrency issues associated within manipulating shared objects 510 involved in the transaction, (c) updating the state of runtime objects involved in the transaction to match the state of the corresponding transaction clones 520 of those runtime objects residing in a transaction area 518, (d) identifying private objects 514 that are rendered into shared objects 510 by the transaction, (e) relocating private objects 514 that are rendered into shared objects 510 from a local area 512 into the global area 508, (f) performing garbage collection operations, and/or (g) performing other operations.

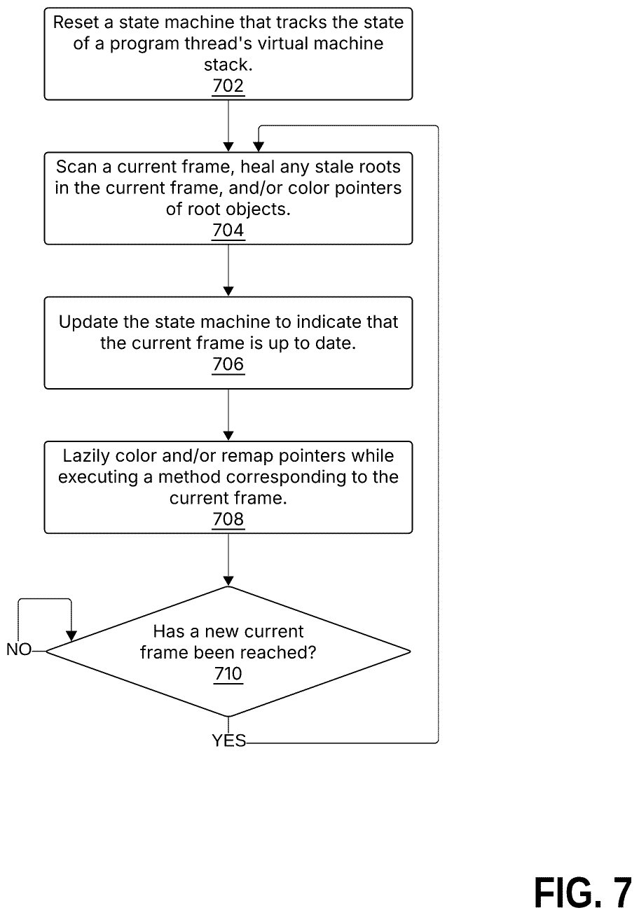

In an embodiment, a barrier 528 is a non-transactional barrier. A non-transactional barrier, such as a non-transactional load barrier or a non-transactional store barrier, may require a program thread 502 to lazily remap stale pointers. In the process of lazily remapping stale pointers, a non-transactional barrier may direct a program thread 502 to perform various operations, such as (a) updating a state machine for the program thread's 502 virtual machine stack, (b) scanning frames in the virtual machine stack, (c) coloring pointers, (d) updating a stack watermark, and (f) performing other operations. Example operations for lazily remapping stale pointers are described below with reference to FIG. 7.

In an embodiment, a barrier 528 is a non-transactional load barrier. An example non-transactional load barrier is imposed on a program thread 502 in response to a load operation that is defined in the instructions for completing a program task that does not trigger a transaction. The example non-transactional load barrier may require the program thread 502 to lazily remap pointers and/or perform garbage collection operations. Furthermore, if the load operation is targeting a shared object 510, the example non-transactional load barrier may require the program thread 502 to (a) perform a check for potential sources of concurrency issues, (b) increment a read counter of the shared object 510, (c) create a local clone of 516 of the shared object 510, and/or (d) perform other operations. Rather than allowing the program thread 502 to directly interact with the shared object 510 targeted by the load operation, the example non-transactional load barrier may direct the program thread 502 to interact with the local clone 516 of the shared object 510.

In an embodiment, a barrier 528 is a non-transactional store barrier. An example non-transactional store barrier is imposed on a program thread 502 in response to a store operation that is defined in the instructions for completing a program task that does not trigger a transaction. The example non-transactional store barrier may instruct the program thread 502 to lazily remap pointers and/or perform garbage collection operations. If the store operation is targeting a shared object 510, the example non-transactional store barrier may prevent the program thread 502 from performing the store operation.

In an embodiment, a watermark 530 refers to a mechanism for tracking the state of a thread's virtual machine stack. For instance, in the example context of the virtual machine memory layout 300 illustrated in FIG. 3, a watermark 530 may be a reference to a frame that is included in virtual machine stack 310 or virtual machine stack 313. In this example, a watermark may be stored to a thread-local storage mechanism of virtual machine stack 310 or virtual machine stack 313. A watermark 530 may be implemented in low-level memory as a pointer, and the pointer may be colored to indicate the state of a frame that is referenced by the pointer and/or the state of the virtual machine stack that includes the frame. A good color 526 and a watermark 530 may be used to implement a state machine for a virtual machine stack of a program thread 502.

In an embodiment, a lock 532 refers to a mechanism for controlling access to shared information. For instance, a lock 532 may be used to restrict access to a shared object 510. If a thread acquires a lock 532 on a shared object 510, other threads may be prevented from manipulating that shared object 510 if the thread retains the lock 532 on the shared object 510. Example locks 532 that may be utilized by system 500 to restrict access to shared objects 510 include mutex locks, read-write locks, spinlocks, re-entrant locks, semaphore locks, and others.

In an embodiment, system 500 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 4. Managing a Transaction

FIG. 6 illustrates an example set of operations for managing a software memory transaction in accordance with one or more embodiments. One or more operations illustrated in FIG. 6 may be modified, rearranged, or omitted. Accordingly, the particular sequence of operations illustrated in FIG. 6 should not be construed as limiting the scope of one or more embodiments.

In an embodiment, the operations illustrated in FIG. 6 are performed by a program thread that is attempting a program task that triggers a transaction. To provide a succinct explanation, the remainder of this Section 4 shall assume the same. However, in other embodiments, some or all of the operations illustrated in FIG. 6 are performed by a thread other than the program thread that is attempting the program task that triggers the transaction. For instance, one or more of the operations described in this Section 4 may be performed by a garbage collector thread or another program thread.

In an embodiment, the operations illustrated in FIG. 6 are performed in a runtime environment implemented using one or more object-oriented program languages. In this embodiment, the techniques described in this Section 4 may be applied to runtime objects. To provide a concise explanation, the remainder of this Section 4 shall assume the same. However, an object-oriented programming language is neither essential nor necessary to practice the techniques described in this Section 4. Furthermore, the techniques described in this Section 4 are equally applicable to data structures other than runtime objects.

In one or more embodiments, the program thread initiates a transaction in response to a request by a program instance (Operation 602). The program instance is requesting that the program thread perform a program task, and the program thread will attempt to complete the program task through the transaction that is presently being initiated. The program instance's instructions for completing the program task refer to one or more runtime objects. The runtime objects that are targeted by the program task may include private objects, shared objects, and/or other runtime objects. Hereafter, the transaction that is presently being initiated in response to the program instance's request is referred to as “the ongoing transaction,” and the operation(s) that are defined in the instructions for completing the program task are referred to as “the program operations.” The program thread initiates the ongoing transaction by preparing to complete the program operations through the ongoing transaction. How the program thread prepares for completing the program operations vary depending on the embodiment and the circumstances of the ongoing transaction. Example operations that may be performed by the program thread to initiate the ongoing transaction include (a) allocating a transaction area for the ongoing transaction, (b) creating a record of the ongoing transaction, (c) updating a record of the most recent event that has been observed by the program thread, (d) updating a record of a most recent transaction to occur in runtime memory, (e) discarding local clones of shared objects that are presently reachable to the program thread, (f) updating read counters of shared objects to reflect the discarding of local clones, and (g) other operations.

In an embodiment, the program thread initiates the ongoing transaction while executing a barrier that is imposed on the program thread in response to the request by the program instance (hereafter “the initiation barrier”). The initiation barrier is an additional set of machine-level instructions that is inserted into the machine-level code of the program instance that is being executed by the program thread. As an example, assume that the ongoing transaction is triggered by an atomic statement in the source code of the program instance. In this example, the initiation barrier may be injected into the machine-level code of the program instance that is being executed by the program thread proximate to the machine-level instructions corresponding to the atomic statement. The program thread may be compelled to execute the initiation barrier prior to performing the program operations in this example. Note that the initiation barrier may be one of multiple barriers that are imposed on the program thread throughout the course of the ongoing transaction. By imposing barriers on the program thread during the ongoing transaction, the program thread may be made to complete the necessary operations to safely perform the program task through the ongoing transaction without any modification having to be made to the instructions for completing the program task. Note that, in some embodiments, a barrier imposed on the program thread during the ongoing transaction may additionally, or alternatively, direct the program thread to perform garbage collection operations, such as coloring pointers, remapping pointers, relocating runtime objects, and/or various other operations that facilitate a garbage collection process.

In an embodiment, the program thread allocates a transaction area while initiating the ongoing transaction. The transaction area will serve as a staging area for completing the program operations. During the ongoing transaction, the program thread will create one or more transaction clones in the transaction area, and the program operations will be applied to the transaction clones. Memory space for the transaction area may be allocated while the program thread is initiating the ongoing transaction, and/or memory space for the transaction area may be allocated incrementally during the ongoing transaction as transaction clones are created.

In an embodiment, the program thread tracks an ordering of events that occur during runtime, and the program thread creates a record of a new event that corresponds to the ongoing transaction while initiating the ongoing transaction. The ordering of events may be a partial ordering of events, or the ordering of events may be a total ordering of events. As an example, assume that the ordering of events is a partial ordering of events. In this example, the events in the partial ordering of events may be synchronization events that have been observed by the program thread during runtime. Other events, such as events that do not pose a risk of creating a concurrency issue or events that are not observed by the program thread, may be excluded from the partial ordering of events in this example. Example mechanisms that may be utilized to track an ordering of events include an object graph of events, Lamport's timestamps, vector clocks, matrix clocks, dependency graphs, causal histories, interval tree clocks, version vectors, logical clocks, hybrid logical clocks, timestamps with logical dependency metadata, and other mechanisms.

In an embodiment, the program thread tracks an ordering of events that occur during runtime by maintaining an object graph of events, and the program thread creates a new event object to represent the ongoing transaction in the object graph of events while initiating the ongoing transaction. Hereafter, an event object that is created to represent the ongoing transaction is referred to as “the ongoing transaction object.” The program thread records the position of the new event within the ordering of events by storing a reference within the ongoing transaction object that points to the event object that represents the most recent event observed by the program thread prior to the ongoing transaction (hereafter “the prior event object”). Note that by the time that ongoing transaction is initiated, the most recent event observed by the program thread is the new event corresponding to the ongoing transaction.

In an embodiment, the program thread tracks an ordering of events that occur during runtime by maintaining an object graph of events, and the most recent event observed by the program thread is tracked by a reference that is maintained by the program thread. When the ongoing transaction object is created, the program thread remaps this reference to the ongoing transaction object. In an example, the reference maintained by the program thread is held by a thread-local storage mechanism of the program thread.

In an embodiment, the program thread updates a record of the most recent transaction to occur in runtime memory to refer to the ongoing transaction. The record of the most recent transaction is collectively maintained by the threads in the runtime environment. In an example, assume that events are recorded using event objects, and the record of the most recent transaction to occur in runtime memory is implemented as a reference to an event object. In this example, this reference may be stored to a global variable, and the program thread remaps this reference to the ongoing transaction object.

In an embodiment, the program thread may discard local clones of shared objects while initiating the ongoing transaction. In particular, the program thread may discard local clones that are reachable to the program thread. Note that committing the ongoing transaction may mutate a shared object, thereby rendering a local clone of that shared object that predates the ongoing transaction outdated. In an example, the program thread discards a local clone of a shared object by breaking chains of references that can be traversed by the program thread to reach that local clone. By breaking these chains of references, the program thread of this example renders the local clone disposable, and the memory space allocated for the local clone may subsequently be reclaimed by a garbage collector.

In an embodiment, the system places the blame for a potential conflict between a read from a shared object and a write to that same shared object on the writer rather than the reader. For example, if the program thread is attempting to mutate a shared object during the ongoing transaction, and if another thread is concurrently attempting a non-transactional read from that same shared object, the system may instruct the program thread to abort the ongoing transaction instead of instructing the other thread to abort the attempt to read from the shared object. To keep track of non-transactional read operations on shared objects while initiating the ongoing transaction, the program thread may decrement a read counter of a shared object when the program thread discards a local clone of that shared object residing in the program thread's local area. In an example, the program thread decrements a read counter of a shared object by updating a value that is stored to an object field of the shared object. Note that the program thread may subsequently rely on read counters of shared objects involved in the ongoing transaction to identify any non-transactional reads from these shared objects by other threads that conflict with write operations that are defined by the ongoing transaction.

In one or more embodiments, the program thread dynamically checks for potential sources of concurrency issues while creating transaction clone(s) for the ongoing transaction (Operation 604). The transaction clones are copies of runtime objects that are targeted by the program task that is being performed through the ongoing transaction. Note that the program operations of the program task will generally reference runtime objects outside of the transaction area. Whenever the program thread attempts to manipulate a runtime object outside of the transaction area while performing a program operation, the program thread will instead be made to manipulate a transaction clone of that runtime object. The program thread may be directed to create a transaction clone of a runtime object the first time that the program thread attempts to manipulate that runtime object during the ongoing transaction. A transaction clone may be a copy of a shared object, a private object, and/or another type of runtime object. In general, the potential for a data race may exist wherever the program task targets a shared object. The ongoing transaction may involve no shared objects, a single shared object, or multiple shared objects. To provide a comprehensive explanation, the remainder of this Section 4 shall assume that the ongoing transaction involves at least one shared object. However, a program task that targets no shared objects may be performed through a transaction. Prior to creating a transaction clone of a shared object and/or manipulating the transaction clone, the program thread may dynamically check for potential sources of concurrency issues associated with the shared object. For brevity, a dynamic check for potential sources of concurrency issues is referred to hereafter as a “concurrency check.”

In an embodiment, the program thread performs a concurrency check on a runtime object and/or creates a transaction clone of that runtime object while executing a barrier that is imposed on the program thread in response to a program operation that is targeting the runtime object. A barrier imposed on the program thread in response to a particular program operation may be a load barrier, a write barrier, or another type of barrier. The program thread may be directed to create a transaction clone of a runtime object involved in the ongoing transaction by a barrier that is imposed on the program thread in response to the first program operation that references that runtime object. If a runtime object involved in the ongoing transaction is a shared object, a barrier imposed on the program thread may instruct the program thread to perform a concurrency check on the shared object prior to creating a transaction clone of the shared object. For example, a load barrier may be imposed on the program thread in response to a program operation that is attempting to load a reference to a shared object. If this program operation is the first attempt to load a reference to this shared object during the ongoing transaction, the load barrier of this example may instruct the program thread to perform a concurrency check on the shared object. If this concurrency check reveals a potential source of a concurrency issue, the load barrier of this example may direct the program thread to abort the ongoing transaction. Alternatively, if this concurrency check does not reveal a potential source of a concurrency issue, the load barrier of this example may direct the program thread to create a transaction clone of the shared object. After creating the transaction clone of the shared object in this example, the load barrier allows the program thread to perform the program operation on the transaction clone rather than the shared object. Furthermore, in this example, any other program operations targeting the shared object may be redirected to the transaction clone of the shared object.

In an embodiment, the program thread performs a concurrency check on a shared object involved in the ongoing transaction by checking for potentially conflicting accesses to the shared object. Two tasks that access the same shared object conflict if (a) the two tasks are being attempted concurrently and (b) at least one of the tasks is attempting to mutate the shared object. As an example, assume that the program task is attempting to mutate a shared object through the ongoing transaction. In this example, another task that is concurrently being performed by another thread conflicts with the program task if the other task is attempting to read from and/or write to the shared object. Note that if both accesses to the shared object are allowed to occur in this example, a data race may result, and the data race may create a concurrency issue.

In an embodiment, the program thread performs a concurrency check on a shared object involved in the ongoing transaction by checking for causally inconsistent accesses to the shared object. Note that in general, accesses to the same shared object potentially conflict with one another if those accesses are causally inconsistent. Two tasks that access the same shared object are causally inconsistent if the observed result or behavior of one task is not consistent with any valid causal ordering that could explain the other task's effects on the shared object. As an example, assume that the program thread is attempting to manipulate a shared object through the ongoing transaction. In this example, the program thread performs a concurrency check by identifying the most recent event to mutate the shared object. If the program thread finds that the effect of the most recent event to mutate the shared object has not been previously observed by the program thread in this example, then the program thread may determine that the program thread's attempt to manipulate the shared object through the ongoing transaction is causally inconsistent with this event. Causally inconsistent accesses to the same shared object often results from a causality bug in a program instance. If accesses to the same shared object are causally inconsistent, those accesses may also conflict with one another. Conflicting accesses may result in a data race, and a data race may lead to a concurrency issue. However, note that not all causally inconsistent accesses to a shared object are conflicting accesses. Furthermore, conflicting accesses do not necessarily create a data race, and a data race does not necessarily create a concurrency issue. As a result, the concurrency issues that are spawned by a causality bug may appear infrequently and seemingly at random during program execution. The sporadic appearances of concurrency issues that result from a causality bug can make it difficult and time consuming to diagnose and resolve that causality bug. However, a concurrency check that is performed on a shared object by the system may identify causally inconsistent accesses that are manifested by a causality bug even if those accesses do not conflict, do not create a data race, and/or do not lead to a concurrency issue. By identifying causally inconsistent accesses even when there is no conflict, no data race, and/or no concurrency issue, the system may greatly simplify diagnosing and resolving a concurrency bug.

In an embodiment, the program thread performs a concurrency check on a shared object involved in the ongoing transaction by comparing (a) an ordering of events that have been observed by the program thread leading up to the ongoing transaction to (b) a most recent event to mutate and/or create the shared object. In an example, the ordering of events maintained by the program thread is a partial ordering of events that (a) reflects an ordering of events observed by the program thread during program execution and (b) does not necessarily reflect the real-time sequence of these events. Example mechanisms that may be utilized by the program thread to track an ordering of events include an object graph of events, Lamport's timestamps, vector clocks, matrix clocks, dependency graphs, causal histories, interval tree clocks, version vectors, logical clocks, hybrid logical clocks, timestamps with logical dependency metadata, and other mechanisms. Additionally, or alternatively, the program thread may perform a concurrency check on a shared object based on comparisons between the real-time occurrences of events. For example, the program thread might compare a timestamp corresponding to the ongoing transaction with another timestamp corresponding to the last access to a shared object.

In an embodiment, the program thread tracks an ordering of events observed by the program thread during runtime by maintaining an object graph of events. The object graph of events is made up of event objects and references between event objects. In this embodiment, the program thread performs a concurrency check on a shared object involved in the ongoing transaction by comparing (a) the object graph of events to (b) an event object that represents the most recent event to mutate and/or create the shared object (hereafter “the last mutation object”). In an example, the program thread identifies a last mutation object by traversing a reference to the last mutation object that is maintained within a shared object that is being subjected to a concurrency check. Having identified the last mutation object in this example, the program thread compares the last mutation object to an object graph of events by traversing a chain of references between event objects originating from the ongoing transaction object. The program thread performs this traversal to determine if the last mutation object is included in the object graph of events prior to the ongoing transaction object in this example. When the program thread traverses a reference to an event object preceding the ongoing transaction object in this example, the program thread checks if that event object is the last mutation object. In addition, the program thread of this example may check if that event object includes any cached results of previous traversals that indicate a relative position of the last mutation object. If (a) this event object is not the last mutation object and (b) this event object does not cache any results of previous traversals that reveal a relative position of the last mutation object, the program thread of this example traverses a reference from this event object to another preceding event object in the object graph of events. In this example, the program thread may continue traversing references between event objects in this manner until (a) identifying a relative position of the last mutation object or (b) reaching the end of the object graph of events. If the last mutation object is included in the object graph of events prior to the ongoing transaction object in this example, the program thread may conclude that the last event to mutate and/or create the shared object is causally consistent with the ongoing transaction, and the program thread may be permitted to proceed in creating a transaction clone of the shared object. Alternatively, if the program thread is unable to find the last mutation object in the object graph of events in this example, the program thread may conclude that there is a causality bug and/or the potential for a data race associated with the ongoing transaction's attempt to manipulate the shared object. As a result, the program thread may be directed to abort the ongoing transaction and/or perform other corrective actions. In either of the foregoing scenarios, the program thread of this example may cache the result of the program thread's traversal of the object graph. For instance, in this example, the program thread may cache the result of the program thread's traversal of the object graph in the ongoing transaction object, the last mutation object, other event objects, and/or other locations.

In an embodiment, when a transaction clone of a shared object is initially created in the transaction area by the program thread, the state of the transaction clone is generally identical to the state of the shared object. However, a shared object involved in the ongoing transaction may be mutated by another thread after a transaction clone of the shared object has been created for the ongoing transaction and while the program operations have yet to be completed. If a shared object involved in the ongoing transaction is mutated by another thread during the ongoing transaction, the state of a transaction clone of that shared object that is being manipulated by the program thread will not be affected by the mutation to the shared object by the other thread. In this scenario, the mutation to the shared object by the other thread conflicts with the program task, and this conflict will be discovered by the program thread while performing a subsequent concurrency check. The subsequent discovery of this conflict may ultimately result in the failure of the ongoing transaction. However, the fact that any mutations to shared objects by other threads during the ongoing transaction do not alter the state of the program thread's transaction clones of those shared objects may nonetheless prevent concurrency issues that might otherwise occur while the program thread is attempting to complete the program operations even if the ongoing transaction ultimately fails. For example, the fact that a mutation by another thread to a shared object during the ongoing transaction does not alter the state of the program thread's transaction clone of that shared object may prevent the program thread from being caught in an infinite loop while attempting to complete a program operation associated with that shared object.

In an embodiment, the program thread performs a concurrency check on a shared object involved in the ongoing transaction by checking for concurrent read operations targeting the shared object that are performed by other threads. Note that another thread concurrently reading from a shared object may conflict with a program operation that is attempting to mutate the shared object. In this embodiment, the responsibility for detecting concurrent reads that potentially conflict with a program operation that is being performed through the ongoing transaction is placed on the program thread. However, it should also be noted that, in other embodiments, the responsibility for detecting a read from a shared object that potentially conflicts with a program operation may be delegated to the other thread that is attempting the read from the shared object rather than the program thread, or it may be the responsibility of both threads to check for potentially conflicting accesses to the shared object. The responsibility for detecting a potential conflict between a read from a shared object by one thread and a write to that same shared object by another thread may or may not correspond to how the system attributes the blame for this potential conflict.

In an embodiment, the system places the blame for a potential conflict between an attempt to read from a shared object and an attempt to write to that same shared object on the writer rather than the reader, and the program thread checks for indirect reads from a shared object involved in the ongoing transaction while performing a concurrency check. The program thread may identify an indirect read from a shared object involved in the ongoing transaction by another thread based off a read counter of the shared object. If the read counter of a shared object is zero, then the program thread can generally assume that there is no local clone of that shared object that is presently accessible to another thread. If there are no local clones of a shared object that are presently accessible to another thread, the program thread may assume that there are no other threads that are presently reading from a local clone of the shared object. Therefore, if the read counter of a shared object is zero, the program thread may be permitted to mutate a transaction clone of that shared object. However, if a read counter of a shared object targeted for mutation by the program task is greater than zero, the program thread may be directed to abort the ongoing transaction, pause the ongoing transaction, and/or perform other corrective actions. In an example, the program thread checks for indirect reads from a shared object that is targeted by the program task while executing a load barrier that is imposed on the program thread. In this example, the load barrier is imposed on the program thread in response to a program operation that is attempting to load a reference to the shared object. In another example, the program thread checks for indirect reads from a shared object that is targeted by the program task while executing a write barrier that is imposed on the program thread. In this other example, the write barrier is imposed on the program thread in response to a program operation that is attempting to mutate the shared object.

In an embodiment, the system places the blame for a potential conflict between an attempt to read from a shared object and an attempt to write to that same shared object on the reader rather than the writer. For example, if the program thread is attempting to mutate a shared object during the ongoing transaction, and if another thread concurrently attempts a non-transactional read from that same shared object during the ongoing transaction, the system may instruct the other thread to abort the attempted read from the shared object instead of instructing the program thread to abort the ongoing transaction.

In an embodiment, the program thread detects private objects that will be rendered into shared objects if and when the ongoing transaction is committed while the program thread is performing the program operations on the transaction clones. Additionally, or alternatively, the program thread detects private objects that will be rendered into shared objects while the program thread is actively committing the ongoing transaction. If the program thread discovers a private object that will be rendered into a shared object by committing the ongoing transaction, the program thread may be instructed to flag that private object for promotion if and when the ongoing transaction is committed. Committing the ongoing transaction may render no private objects into shared objects, a single private object into a shared object, or multiple private objects into shared objects. In general, if one runtime object includes a traversable reference to another runtime object, any thread that can access the one runtime object can also access the other runtime object. A private object is rendered into a shared object if committing the ongoing transaction will create a new reference to that private object that originates from another shared object. Note that one private object becoming a shared object may result in other private objects also becoming shared objects if the other private objects are referenced by the one private object. Thus, when the program thread detects a new reference from a shared object to a private object that is created by the ongoing transaction, the program thread may be made to traverse any chains of references originating from that private object to identify any other private objects that may be rendered into shared objects as result of the new reference being stored to the shared object when the ongoing transaction is committed.

In an embodiment, the program thread identifies a private object that will be rendered into a shared object while executing a store barrier imposed on the program thread in response to the store operation that renders the private object into a shared object. As an example, assume that the program operation is attempting to store a new reference to a field of a shared object, and further assume that a store barrier is imposed on the program thread in response to the program operation. In this example, the store barrier directs the program thread to determine if the new reference points to a private object. If the new reference points to a private object in this example, the program thread concludes that the private object will be rendered into a shared object if and when the ongoing transaction is committed. Accordingly, the store barrier of this example instructs the program thread to flag the private object for promotion when the ongoing transaction is committed, and the store barrier directs the program thread to determine if the private object refers to any other private objects that will also become shared objects as a result of references originating from the private object. If the program thread identifies other private objects that will also become shared objects, the store barrier of this example further instructs the program thread to flag these other private objects for promotion if and when the ongoing transaction is committed.

In one or more embodiments, the program thread attempts to acquire lock(s) on shared object(s) involved in the ongoing transaction (Operation 606). The program thread attempts to acquire the locks on the shared objects once the program operations are completed. In other words, the program thread attempts to acquire locks on the shared objects once the program thread has finished manipulating the transaction clones of the runtime objects that are targeted by the program task. The program thread may attempt to acquire locks on a subset of the shared objects involved in the ongoing transaction, or the program thread may attempt to acquire locks on the totality of the shared objects involved in the ongoing transaction. In an example, the program thread attempts to acquire locks for at least those shared objects that will be mutated if and when the ongoing transaction is committed. An inability to acquire a lock on a shared object that is involved in the ongoing transaction may indicate that another thread is concurrently attempting to mutate that shared object. In this way, an attempt to acquire a lock on a shared object involved in the ongoing transaction may serve as an additional concurrency check. If the program thread is unable to acquire a lock on a shared object involved in the ongoing transaction, then the program thread may be directed to abort the ongoing transaction, pause the ongoing transaction, and/or perform other corrective actions.

In an embodiment, the program thread attempts to acquire a lock on a shared object involved in the ongoing transaction while executing a barrier that is imposed on the program thread. For instance, the program thread may be directed to acquire locks on shared objects by a barrier that is imposed on the program thread after the program operations are completed (hereafter “the commit barrier”). Additionally, or alternatively, the program thread may be directed to acquire locks on shared objects by other barriers that are imposed on the program thread while the program operations are still being applied to the transaction clones.

In one or more embodiments, the program thread performs additional checks for potential sources of concurrency issues (i.e., additional concurrency checks) on shared object(s) involved in the ongoing transaction while holding locks on the shared object(s) (Operation 608).

The program thread may perform these additional concurrency checks on a subset of the shared objects involved in the ongoing transaction, or the program thread may perform additional concurrency checks on the totality of the shared objects involved in the ongoing transaction. A concurrency check that is performed on a shared object in this operation may be an “additional” concurrency check because the program thread may have previously performed a concurrency check on the shared object while attempting a program operation that targets the shared object. Note that, in this scenario, the prior concurrency checks did not reveal potential sources of concurrency issues. If a shared object involved in the ongoing transaction has been accessed by another thread in a manner that conflicts with a program operation in the time that has elapsed since a prior concurrency check was performed on the shared object, an additional concurrency check that is performed on this shared object in this operation will detect the subsequent conflicting access. For example, if a shared object has been mutated by another thread since a transaction clone of the shared object was created for the ongoing transaction, an additional concurrency check on that shared object will reveal the intervening mutation by the other thread. However, note that no other thread will be able to mutate a shared object while the program thread holds a lock on that shared object. Therefore, if the additional concurrency checks that are performed while holding these locks do not reveal any potential sources of concurrency issues, the program thread may assume that the ongoing transaction can be safely committed. However, if these additional concurrency checks do reveal a potential source of a concurrency issue, then the program thread may be directed to abort the ongoing transaction, pause the ongoing transaction, and/or perform other corrective actions.

In an embodiment, the program thread performs an additional concurrency check on a shared object involved in the ongoing transaction while executing a barrier that is imposed on the program thread. The program thread may perform the additional concurrency checks on the shared objects involved in the ongoing transaction while executing the commit barrier. Additionally, or alternatively, the program thread may be directed to perform the additional concurrency checks on the shared objects while executing other barriers that are imposed on the program thread during the ongoing transaction.

In one or more embodiments, the program thread commits the ongoing transaction (Operation 610). The program thread commits the ongoing transaction by updating the state of runtime objects that are targeted for mutation by the program task that is being performed through the ongoing transaction. In particular, the program thread commits the ongoing transaction by updating runtime objects that are targeted for mutation by the program task to match the state of the corresponding transaction clones of these runtime objects to which the instructions for completing the program task have been applied. Note that the runtime objects that are targeted for mutation by the program task may include private objects as well as shared objects. The program thread updates the state of shared objects involved in the ongoing transaction while still holding the locks for those shared objects. In addition to updating the state of runtime objects to match the state of the corresponding transaction clones, the program thread may relocate certain runtime objects that are affected by committing the ongoing transaction. For example, the program thread may relocate new runtime objects that are created by the program task, and/or the program thread may relocate private objects that are rendered into shared objects by committing the ongoing transaction. After committing the ongoing transaction, the program thread may release the locks on the shared objects, and the program thread may discard the transaction clones residing in the transaction area.

In an embodiment, the program thread commits the ongoing transaction while executing the commit barrier that is imposed on the program thread at the tail end of the ongoing transaction. The commit barrier that instructs the program thread to commit the ongoing transaction may be the same barrier that instructs the program thread to acquire locks on shared objects involved in the ongoing transaction and/or perform the additional concurrency checks on these shared objects. Additionally, or alternatively, these other operations may be performed by other barriers that are imposed on the program thread during the ongoing transaction.

In an embodiment, the program thread detects private objects that are being rendered into shared objects as the program thread is actively committing the ongoing transaction. Additionally, or alternatively, the program thread may identify private objects that will be rendered into shared objects as a result of committing the ongoing transaction while the program thread is still in the process of performing the program operations on the transaction clones. If a runtime object is rendered from a private object into a shared object when the ongoing transaction is committed, the program thread may flag that runtime object for promotion. In an example, the program thread identifies a runtime for promotion by comparing (a) the state of a shared object prior to committing the ongoing transaction to (b) the state of the shared object after the shared object is updated to match the mutated state of a corresponding transaction clone. In this example, the program thread concludes that the runtime object should be promoted because the foregoing comparison reveals that committing the ongoing transaction creates a new reference in the shared object that points to the runtime object. In another example, the program thread identifies a runtime object for promotion by comparing (a) the state of a shared object prior to committing the ongoing transaction to (b) the mutated state of a transaction clone of the shared object after the final program operation that manipulates the transaction clone is completed.

In an embodiment, the program thread's private objects reside in a local area that is specifically allocated for the program thread, and the program thread promotes runtime object(s) that are rendered into shared object(s) while committing the ongoing transaction. The program thread promotes a runtime object from the program thread's local area by creating a new copy of that runtime object in a global area that is generally allocated for shared objects. A copy of a runtime object that is generated in the global area may be copied from the program thread's local area or the transaction area. After a runtime object is promoted to the global area, the local copy of that runtime object may be discarded. Notwithstanding, stale pointers to the local address of a runtime object may persist in runtime memory after the runtime object is promoted to the global area during the ongoing transaction. When the program thread promotes a runtime object from the local area to the global area, the system may record a mapping between the runtime object's local address and the runtime object's global address. In some cases, a stale pointer to the local address of a runtime object that has been promoted to the global area may need to be remapped to the runtime object's global address after the ongoing transaction is completed. A stale pointer to the local address of a runtime object that has been promoted will need to be remapped if a thread subsequently attempts to load the reference corresponding to the stale pointer at the behest of the program instance. However, it may be that no thread subsequently attempts to load a reference corresponding to a stale pointer after the ongoing transaction is completed. As a result, eagerly remapping a stale pointer to the local address of a runtime object that has been promoted may be a needless computational cost in some cases. To avoid the computational cost associated with needlessly remapping stale pointers, the system may direct threads to lazily remap stale pointers after the ongoing transaction is completed. Example operations for lazily remapping stale pointers are described below with reference to FIG. 7.

### 5. Lazily Remapping Stale Pointers

FIG. 7 illustrates an example set of operations for lazily remapping stale pointers in accordance with one or more embodiments. One or more operations illustrated in FIG. 7 may be modified, rearranged, or omitted. Accordingly, the sequence of operations illustrated in FIG. 7 should not be construed as limiting the scope of one or more embodiments.

In an embodiment, the operations illustrated in FIG. 7 are performed by a program thread that has recently committed a transaction; to provide a succinct explanation, the remainder of this Section 5 shall assume the same. However, in other embodiments, some or all of the operations illustrated in FIG. 7 are performed by a thread other than the program thread that has recently committed the transaction.

In an embodiment, the operations illustrated in FIG. 7 are performed in a runtime environment implemented using one or more object-oriented programming languages. In this embodiment, the operations illustrated in FIG. 7 may manipulate runtime objects. To provide a concise explanation, the remainder of this Section 5 shall assume the same. However, an object-oriented programming language is neither essential nor necessary to practice the techniques described in this Section 5. Furthermore, the techniques described in this Section 5 are equally applicable to data structures other than runtime objects.

In one or more embodiments, a program thread resets a state machine that tracks the current state of the program thread's virtual machine stack (Operation 702). In particular, the state machine tracks if frames in the virtual machine stack are up to date with respect to a transaction that has recently been committed by the program thread (hereafter “the committed transaction”). Resetting the state machine designates a new current state for frames in the program thread's virtual machine stack. In the instant that immediately follows the reset of the state machine, the frames in the program thread's virtual machine stack will be considered outdated. Subsequently, any frame in the virtual machine stack that is actively being manipulated by the program thread will be expected to be up to date with the new current state before a method corresponding to that frame can be executed. How the state machine is implemented and reset may vary between embodiments.

In an embodiment, the program thread resets the state machine while executing a barrier that is imposed on the program thread. The barrier may be a load barrier, a store barrier, a commit barrier, or another barrier. In an example, the barrier that instructs the program thread to reset the state machine is imposed on the program thread proximate to the completion of the committed transaction.

In an embodiment, the program thread resets the state machine by determining a new good color for a stack watermark of the virtual machine stack. The current good color for the stack watermark may be stored to a thread-local storage mechanism, stored in a global variable, embedded into barrier logic, and/or maintained in another location. Designating a new good color for the stack watermark renders the previous good color for the stack watermark into a bad color. Consequently, the stack watermark will now be embedded with a bad color the moment that the new good color is decided. The stack watermark embedding a bad color indicates that the frames in the program thread's virtual machine stack are presently outdated.

In one or more embodiments, the program thread scans the current frame for roots, heals any stale roots in the current frame, and/or colors pointers of root objects that are referenced by roots in the current frame (Operation 704). When the program thread identifies a root while scanning the current frame, the program thread determines if the root is stale. To this end, the program thread may verify if a root in the current frame is pointing to the correct address in memory following the completion of the committed transaction. If a root is pointing to the wrong address in memory (i.e., stale), the program thread remaps the root to the correct address. For example, if a root is pointing to the local address of a runtime object that was promoted by the committed transaction, the program thread may remap the root to the runtime object's global address. In this example, the program thread may remap the root based on a mapping between the runtime object's local address and the runtime object's global address that was recorded at the time the runtime object was promoted by the committed transaction. Once the program thread has verified that a root is pointing to the correct address, the program thread may traverse that root to a root object. After traversing a root to a root object, the program thread identifies any references held by the root object that refer to other runtime objects. Upon identifying a reference to another runtime object that is held by a root object, the program thread may alter the coloring of a pointer in low-level memory that is used to implement the reference. For instance, if (a) a root object refers to another runtime object and (b) the coloring of the pointer that refers to the other runtime object indicates that the pointer does not need to be remapped, the program thread may alter the coloring of the pointer to indicate that the pointer may need to be remapped. In an example, a pointer from a root object to another runtime object includes a set of bits that are used to track if the pointer is known to refer to the correct address (hereafter “the remapping bits”), and the program thread alters the coloring of the pointer by inserting a bad color into the remapping bits of the pointer. Inserting the bad color into the remapping bits of the pointer in this example ensures that a thread will verify that the pointer refers to the correct address if that thread subsequently attempts to dereference the pointer. The program thread may repeat the foregoing process for any given root that is included in the current frame.

In an embodiment, the program thread scans the current frame for roots, heals any stale roots in the current frame, and/or colors pointers of root objects that are referenced by roots in the current frame while executing a barrier that is imposed on the program thread. The barrier instructs the program thread to complete these operations because the current frame is outdated. In an example, the barrier is the first barrier that is imposed on the program thread as the program thread is attempting to perform the method corresponding to the current frame.

In an embodiment, the program thread determines that the current frame is outdated based on a stack watermark of the program thread's virtual machine stack. As an example, assume that (a) the stack watermark is implemented as a pointer that refers to a frame in the program thread's virtual machine stack and (b) the program thread resets the state machine by determining a new good color corresponding to the new current state. For the purposes of this example, further assume that the program thread's virtual machine stack grows downward. In this example, if the current frame is the first frame to be scanned since the committed transaction was completed, the program thread may conclude that the current frame is outdated because (a) a bad color is embedded into the pointer that implements the stack watermark and/or (b) the current frame is above the frame that is referenced by the pointer. Alternatively, if the current frame is not the first frame to be scanned since the committed transaction was completed in this example, the pointer that is used to implement the stack watermark may already embed the new good color, and the program thread may conclude that the current frame is outdated because the stack watermark refers to frame in the virtual machine stack that is above the current frame.

In one or more embodiments, the program thread updates the state machine to indicate that the current frame is now up to date with the new current state of the virtual machine stack (Operation 706). In other words, the program thread updates the state machine to indicate that it is now safe to perform the method corresponding to the current frame following the completion of the committed transaction. After the state machine has been updated to indicate that the current frame complies with the new current state, the program thread may be permitted to perform the method corresponding to the current frame.

In an embodiment, the program thread updates the state machine to indicate the current frame is up to date while executing a barrier that is imposed on the program thread. In an example, this barrier is the first barrier that is imposed on the program thread as the program thread is attempting to perform the method corresponding to the current frame.

In an embodiment, the state machine relies on a stack watermark to track the frames in the program thread's virtual machine stack that are up to date with the new current state, and the program thread updates the state machine to indicate that the current frame is up to date with the new current state by altering the stack watermark. As an example, assume that (a) the stack watermark is implemented as a pointer to a frame in the program thread's virtual machine stack and (b) the program thread resets the state machine by determining a new good color for the stack watermark. If the current frame is the first frame to be scanned since the committed transaction was completed in this example, the program thread may update the stack watermark by (a) embedding the new good color into the pointer that is used to implement the stack watermark and (b) remapping this pointer to the current frame. Alternatively, if the current frame is not the first frame to be scanned since the committed transaction was completed as in this example, the new good color may already be embedded in the pointer, and the program thread updates the stack watermark by remapping the pointer to the current frame.

In one or more embodiments, the program thread lazily remaps and/or recolors pointers while performing the method corresponding to the current frame (Operation 708). In particular, the program thread remaps and/or recolors pointers corresponding to references that are accessed by the program thread while performing the method corresponding to the current frame. When the program thread encounters a reference while performing the method, the program thread temporarily pauses performing the method to check if the pointer requires remapping. The program thread determines if a pointer requires remapping based on the coloring of the pointer. In general, a pointer may require remapping if the pointer embeds a bad color. For example, if the program thread encounters a pointer that embeds a bad color within a set of remapping bits of the pointer, the program thread verifies if the pointer is mapped to the correct address. If the pointer is not mapped to the correct address in this example, the program thread will remap the pointer. Once the program thread has verified that the pointer refers to the correct address, the program thread will recolor the remapping bits of the pointer with the current good color in this example. Furthermore, in this example, the program thread may subsequently traverse the pointer to a runtime object (hereafter “the target object”) that resides at the address that is correctly reference by the pointer. Upon traversing the pointer to the target object in this example, the program thread identifies any references held by the target object that refer to other runtime objects. If the target object refers to another object in this example, the program thread alters the coloring of the corresponding pointer to embed a bad color in this corresponding pointer's remapping bits if that corresponding pointer does not already embed the bad color. As a result, if a thread subsequently encounters this reference held by the target object in this example, that thread will know to verify if this reference requires remapping. In this example, the program thread may embed a bad color into any given pointer originating from the target object. After the coloring and/or remapping of these pointers is complete, the program thread may resume executing the method corresponding to the current frame as in this example. The foregoing process may be repeated for any given reference to a runtime object that is accessed by the program thread while performing the method corresponding to the current frame. However, note that once this process is completed for the first time with respect to a given reference, this process will not be repeated for the given reference unless the state machine is subsequently reset.

In an embodiment, the program thread colors and/or remaps pointers while executing barriers that are imposed on the program thread in response to operations that are performed in furtherance of the method corresponding to the current frame. For example, a load barrier may be imposed on the program thread in response to an operation in the method corresponding to the current frame that loads a reference to a runtime object (hereafter “the target object”). Prior to accessing the target object through the reference in this example, the load barrier may require the program thread to recolor and/or remap a pointer corresponding to the reference if this pointer embeds a bad color within a set of remapping bits. Furthermore, the load barrier may direct the program thread to insert bad colors into pointers that originate from the target object as in this example.

In one or more embodiments, the program thread determines if a new current frame has been reached, and the program thread proceeds to another operation based on the determination (Operation 710). If the program thread has reached a new current frame, the program thread returns to Operation 704. Alternatively, if the program thread has not reached a new current frame, the program thread will repeat this operation.

### 6. Reading from Shared Data Outside of a Transaction

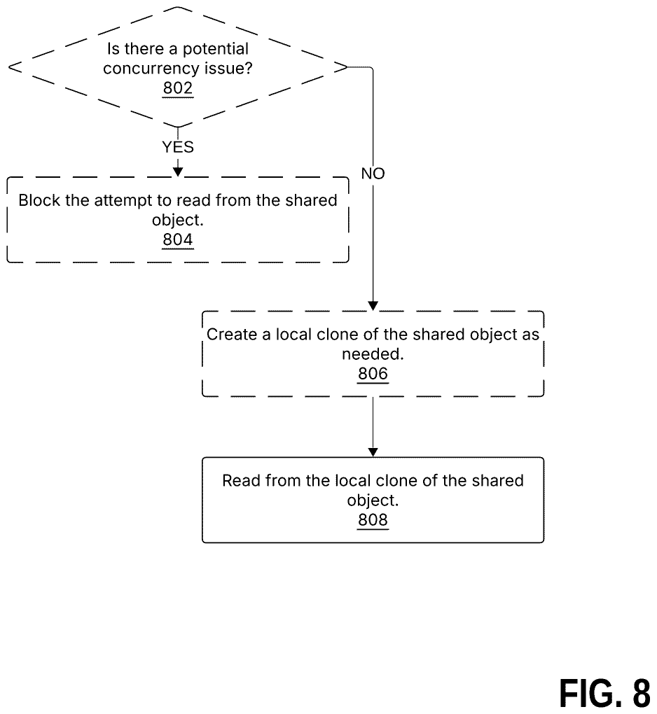

FIG. 8 illustrates an example set of operations for managing an attempt to read from a shared data structure outside of a software memory transaction in accordance with one or more embodiments. One or more operations illustrated in FIG. 8 may be modified, rearranged, or omitted. Accordingly, the sequence of operations illustrated in FIG. 8 should not be construed as limiting the scope of one or more embodiments.

In an embodiment, the operations illustrated in FIG. 8 are performed by a program thread that is attempting to read from the shared data structure outside of a transaction; to provide a succinct explanation, the remainder of this Section 6 shall assume the same. However, in other embodiments, some or all of the techniques described in this section are performed by a thread other than the program thread that is attempting to read from the shared data structure.

In an embodiment, the operations illustrated in FIG. 8 are performed in a runtime environment implemented using one or more object-oriented programming languages. In this embodiment, the operations illustrated in FIG. 8 may manipulate runtime objects. For instance, in this embodiment, the shared data structure that the program thread is attempting to read from may be a shared object. To provide a concise explanation, the remainder of this this Section 6 shall assume the same. However, an object-oriented programming language is neither essential nor necessary to practice the techniques described in this Section 6. Furthermore, the techniques described in this Section 6 are equally applicable to data structures other than runtime objects.

In one or more embodiments, the program thread checks for potential causes of concurrency issues that may be associated with reading from a shared object, and the program thread proceeds to another operation based on the outcome of the check (Operation 802). The program thread checks for potential causes of concurrency issues in response to a request by a program instance for the program thread to read from the shared object. Note that the request by the program instance is neither a trigger for a transaction nor part of a program task that is being performed through a transaction. For brevity, a check for potential sources of concurrency issues is referred to hereafter as “a concurrency check.” In other embodiments, the system may not direct the program thread to perform a concurrency check. For example, in some embodiments, the responsibility for detecting an access to the shared object by another thread that potentially conflicts with the program thread's attempt to read from the shared object may be delegated to the other thread instead of the program thread. If the program thread is instructed to perform a concurrency check, and if the concurrency check reveals a potential cause of concurrency issue, the program thread proceeds to Operation 804. For example, if a concurrency check reveals another access to the shared object that is causally inconsistent and/or conflicts with the attempt to read from the shared object, the program thread may proceed to Operation 804. On the other hand, if the program thread is instructed to perform a concurrency check, and if the concurrency check does not reveal a potential source of a concurrency issue, the program thread proceeds to Operation 806. Similarly, if the system does not compel the program thread to perform a concurrency check, the program thread skips this operation and proceeds to Operation 806.

In an embodiment, the program thread performs a concurrency check while executing a barrier that is imposed on the program thread. As an example, assume that the program instance instructs the program to load a reference to the shared object, so the program thread can read from the shared object pursuant to the program instance's request. In this example, a load barrier is imposed on the program thread in response to the program instance's request to load the reference to the shared object. The load barrier of this example is inserted into the instructions provided to the program thread by the program instance proximate to the instructions for loading the reference.

In an embodiment, the program thread performs a concurrency check on the shared object by discerning if there are any potentially conflicting writes to the shared object by another thread. Another task that is being performed by another thread will, for example, conflict with the program thread's attempt to read from the shared object if (a) that other task is being performed concurrently and (b) that other task is attempting to mutate the shared object. At present, the program thread is attempting to read from the shared object targeted by the program instance's request. For at least the time being, the program thread is not attempting to mutate this shared object. Therefore, the program thread may refrain from checking for concurrent reads from the shared object at this time. However, in some cases, two or more concurrent reads from a shared object can lead to a concurrency issue even if those reads do not contribute to creating a data race. For example, two or more reads from the same shared object that are performed concurrently could result in race-like conditions if those two reads are allowed to read from different views of the same shared object. Thus, in other embodiments, the program thread may be directed to check for concurrent reads from the shared object at this time.

In an embodiment, if there is a potential conflict between a read from a shared object by one thread and a write to that same shared object by another thread, the system will generally place the blame on the reader rather than the writer. As noted above, the program instance is requesting that the program thread read from a shared object. Therefore, the program thread is considered a reader rather than a writer at least for the time being. In this embodiment, the responsibility for detecting a potential conflict between the program thread's attempt to read from the shared object and a mutation to that shared object may also be delegated to the program thread. Accordingly, the system directs the program thread to perform a concurrency check on the shared object in this embodiment, and the outcome of the program thread's attempt to read from the shared object may depend on the result of the check.

In an embodiment, the system generally attributes the blame for a potential conflict between a read from a shared object and a write to that same shared object on the writer rather than the reader. In this embodiment, the responsibility for detecting a conflict and/or causal inconsistency between the program thread's attempt to read from the shared object and another thread's attempt to mutate the shared object may be delegated to the mutator rather than the program thread. Thus, the system may not instruct the program thread to perform the concurrency check on the shared object in this embodiment.

In an embodiment, the system may not instruct the program thread to perform a concurrency check on the shared object regardless of how the system attributes the blame for a potential conflict between a read from a shared object and a write to that same shared object. For example, if the program thread has recently loaded a reference to the shared object that is targeted by the program instance's request, and if there is a pre-existing local clone of this shared object that is still reachable to the program thread, the system may permit the program thread to read from the pre-existing local clone without checking for potential causes of concurrency issues associated with reading from the shared object. In another example, the system instructs the program thread to check potential sources of concurrency issues associated with reading from the shared object even if there is a pre-existing local clone of the shared object that is reachable to the program thread.

In an embodiment, the program thread performs a concurrency check on the shared object by comparing (a) an ordering of events observed by the thread leading up to the present to (b) a most recent event to mutate and/or create the shared object. In an example, the ordering of events maintained by the program thread is a partial ordering of events that (a) reflects a happens-before ordering of events observed by the program thread during program execution and (b) does not necessarily reflect the real-time sequence of these events. Example mechanisms that may be utilized by the program thread to track an ordering of events include an object graph of events, Lamport's timestamps, vector clocks, matrix clocks, dependency graphs, causal histories, interval tree clocks, version vectors, logical clocks, hybrid logical clocks, timestamps with logical dependency metadata, and other mechanisms. Additionally, or alternatively, the program thread may perform a concurrency check on the shared object based on a comparison between the real time occurrences of events.

In an embodiment, the program thread tracks an ordering of events during runtime by maintaining an object graph of events, and the program thread performs a concurrency check on the shared object by comparing (a) the object graph of events to (b) an event object that represents the most recent event to mutate and/or create the shared object (hereafter “the last mutation object”). In an example, the program thread identifies the last mutation object by traversing a reference to the last mutation object that is maintained within the shared object. Having identified the last mutation object in this example, the program thread compares the last mutation object to the object graph of events by traversing a chain of references between event objects in the object graph of events originating from the event object that represents the most recent event that has been observed by the program thread (hereafter “the most recent event object”). In this example, the program thread may maintain a reference to the most recent event object that can be traversed by the program thread to begin the comparison with the object graph. If the last mutation object is not the most recent event object in this example, the program thread may check for any cached results of other traversals that may be stored in the most recent event object. If there are no cached results in the most recent event object that indicate a relative position of the last mutation object, the program thread of this example will traverse a reference originating from the most recent event object that points to another event object that precedes the most recent event object in the object graph of events. In this example, the program thread may continue traversing the object graph of events in this manner until (a) finding the last mutation object within object graph, (b) identifying a relative position of the last mutation object based on a cached result of a prior traversal, or (c) reaching the end of the object graph of events. If the program thread finds that the last mutation object is included in the object graph of events prior to the most recent event object, the program thread may conclude that there is currently no indication of a causality bug or a potential data race associated with the read operation in this example. Alternatively, if the program thread is unable to find the last mutation object in the object graph of events in this example, the program thread may conclude that there is a causality bug and/or a potential data race. In either of the foregoing scenarios, the program thread of this example may cache the result of the program thread's traversal of the object graph. For instance, in this example, the program thread may cache the result of the program thread's traversal of the object graph in the most recent event object, the last mutation object, other event objects, and/or other locations.

In one or more embodiments, the program thread blocks the attempt to read from the shared object in response to identifying a potential cause of a concurrency issue associated with reading from the shared object (Operation 804). For example, the program thread may be blocking the attempt to read from the shared object in response to identifying a concurrent write to the shared object that is causally inconsistent with the attempt to read from the shared object. In this example, the system may assume that the concurrent write potentially conflicts with the attempt to read from the shared object due to these accesses being causally inconsistent, and the system attributes the blame for this potential conflict on the reader (i.e., the program thread) rather than the writer. Thus, in this example, the system directs the program thread to block the attempt to read from the shared object to prevent any data races and/or concurrency issues that might otherwise result from allowing the read to occur. Note that in other examples, the system may refrain from blocking the attempt to read from the shared object unless it is confirmed that this read would conflict with another task and/or result in a data race or a concurrency issue.

In an embodiment, the program thread blocks the attempt to read from the shared object while executing a barrier that is imposed on the program thread. For example, the program thread may block the attempt to read from the shared object while executing a load barrier that is imposed on the program thread in response to the program thread loading a reference to the shared object ahead of the requested read. In addition to blocking the attempted read, the barrier may require the program thread to perform other corrective actions such as flagging a causality bug that was detected by a concurrency check.

In one or more embodiments, the program thread creates a local clone of the shared object (Operation 806). In this scenario, either (a) a concurrency check did not reveal any potential source of a concurrency issue, or (b) the program thread was not required to perform a concurrency check on the shared object. Thus, the program thread will create a local clone of the shared object if there is not a pre-existing local clone of the shared object that is accessible to the program thread. If there is a pre-existing local clone of the shared object that is accessible to the program thread, the system may direct the program thread to generate a new local clone, update the preexisting local clone, or skip this operation.

In an embodiment, the program thread creates the local clone of the shared object while executing a barrier that is imposed on the program thread. For example, the program thread may create the local clone of the shared object while executing a load barrier that is imposed on the program thread in response to the program thread loading a reference to the shared object ahead of the requested read.

In one or more embodiments, the program thread reads from the local clone of the shared object (Operation 808). As noted above, the program instance is requesting that the program thread read from the shared object; however, the system instructs the program thread to read from the local clone of the shared object instead of reading from the shared object. Note that forcing the program thread to read from the local clone rather than the shared object may prevent a concurrency issue that might otherwise occur due to another thread mutating the shared object while the program thread is executing logic that is a function of the shared object's state.

In an embodiment, the program thread is directed to read from the local clone of the shared object rather than read from the shared object itself by a barrier that is imposed on the program thread. For example, the program thread may be directed to read from the local clone of the shared object by a load barrier that is imposed on the program thread in response to the program thread loading a reference to the shared object ahead of the requested read.

In an embodiment, the program thread is subsequently prevented from mutating the local clone of the shared object. For example, if the program thread attempts to write to an object field of the local clone at the direction of the program instance, a barrier imposed on the program thread in response to the attempted write operation may instruct the program thread to throw an exception. In an alternative embodiment, the program thread may be permitted to mutate the local clone of the shared object.

### 7. Example Embodiment

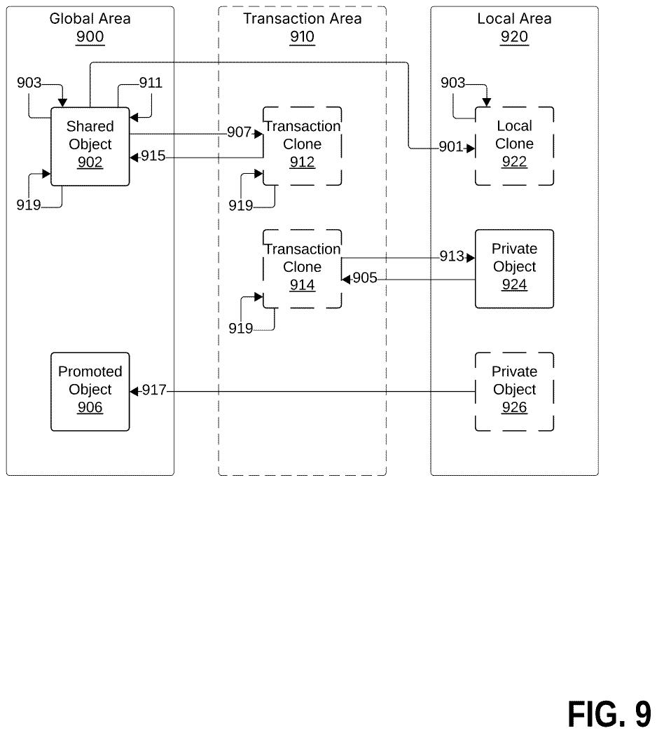

FIG. 9 illustrates an example set of operations for managing example interactions with data structures in a concurrent computing environment in accordance with an example embodiment. A detailed example is described below for purposes of clarity. Components and/or operations described below should be understood as one specific example that may not be applicable to certain embodiments. Accordingly, components and/or operations described below should not be construed as limiting the scope of any of the claims.

In an example embodiment, a program thread creates a local clone 922 of a shared object 902 in a local area 920 of the program thread, and the program thread increments the read counter of the shared object 902 (Operation 901). The program thread creates the local clone 922 and increments the read counter of the shared object 902 while executing a load barrier that is imposed on the program thread. The load barrier is imposed on the program thread in response to a request by a program instance that is being performed, at least in part, by the program thread. The request by the program instance instructs the program thread to load a reference to the shared object 902 and read from the shared object 902. Rather than allowing the program thread to read from the shared object 902, the load barrier instructs the program thread to create the local clone 922 of the shared object 902 in the program thread's local area 920. For the purposes of this example, assume that the system places the blame for a potential conflict between an attempt to read from a shared object and an attempt to write to that same shared object on the writer rather than the reader. In this example operation, the program thread is the reader rather than the writing. Accordingly, the load barrier instructs the program thread to increment the shared object's 902 read counter, so non-transactional reads from the shared object 902 can be tracked by any other threads that may be attempting to concurrently mutate the shared object. After creating the local clone 922, the load barrier permits the program thread to perform the read operation that is requested by the program instance on the local clone 922 rather than the shared object 902.

In an example embodiment, the program thread discards the local clone 922 of the shared object 902 and decrements the read counter of the shared object 902 while initiating a transaction (Operation 903). Hereafter, the transaction that is initiated by the program thread is referred to as “the ongoing transaction.” The program thread discards the local clone 922 and decrements the read counter of the shared object 902 while executing a barrier that is imposed on the program thread at the onset of the ongoing transaction (hereafter “the initiation barrier”). The initiation barrier is imposed on the program thread in response to a request by the program instance for the program thread to perform a program task that triggers the ongoing transaction. For instance, the initiation barrier may be imposed on the program thread in response to an atomic statement in the source code of the program instance. The instructions for completing the program task define operations that are attempting to manipulate runtime objects residing in global area 900 and local area 920 (hereafter “the program operations”). In particular, the program operations are attempting to manipulate shared object 902 and private object 924. In addition to discarding the local clone 922 and decrementing the read counter of the shared object 902, the initiation barrier may direct the program thread to otherwise prepare for attempting the program task through the ongoing transaction, such as creating an event object to represent the ongoing transaction, storing a reference to this event object in a field that is used to track the most recent event observed by the program thread, allocating a transaction area 910 for the ongoing transaction, and/or other operations.

In an example embodiment, the program thread creates a transaction clone 914 of the private object 924 in a transaction area 910 that is allocated for the ongoing transaction (Operation 905). The program thread creates the transaction clone 914 while executing a load barrier that is imposed on the program thread. The load barrier is imposed on the program thread in response to the first program operation that attempts to load a reference to the private object 924 during the ongoing transaction. Rather than allowing the program operations to be applied directly to the private object 924 as has been requested by the program instance, the load barrier instructs the program thread to create the transaction clone 914 of the private object 924 in the transaction area 910. After creating the transaction clone 914, the program thread is directed to manipulate the transaction clone 914 rather than the private object 924 while completing the program operations. For the purposes of this example, assume that the program thread subsequently mutates the transaction clone 914 of the private object 924 while completing the program operations.

In an example embodiment, the program thread checks for potential sources of concurrency issues associated with the shared object 902, and the program thread creates a transaction clone 912 of the shared object 902 in the transaction area 910 (Operation 907). For brevity, a check for potential sources of concurrency issues associated with manipulating a runtime object is referred to as a “concurrency check.” The program thread checks for potential sources of concurrency issues and creates the transaction clone 902 while executing a load barrier that is imposed on the program thread. The load barrier is imposed on the program thread in response to the first program operation that attempts to load a reference to the shared object 902 during the ongoing transaction. In this example, the program operation is attempting to load the reference to the shared object 902, so a new reference can be written to an object field of the shared object 902. Pursuant to the logic defined in the load barrier, the program thread accesses the read counter of the shared object 902 to check for non-transactional read operations that potentially conflict with the program operation's attempt to write to the shared object 902. For the purposes of this example, assume that the read counter of the shared object 902 is presently zero. The read counter recording a value of zero indicates that there are presently no local clones of the shared object 902 that are being manipulated by other threads. Thus, the program thread assumes that, at this point in the ongoing transaction, there are no concurrent tasks indirectly reading from the shared object 902 in a matter that might conflict with the program task. Note that in an alternative example, the foregoing check for conflicting reads is performed by the program thread while executing a write barrier that is imposed on the program thread after the present load barrier. After confirming the absence of conflicting reads in this example, the load barrier further instructs the program thread to check for mutations to the shared object 902 by other threads that potentially conflict with the reads and/or writes to the shared object 902 that are being attempted by the program operations. To this end, the program thread compares (a) a partial ordering of events that have been observed by the program thread leading up to the ongoing transaction to (b) the most recent event to mutate and/or create the shared object 902. In this example, the most recent event to mutate and/or create the shared object 902 is included in the partial ordering of events that have been observed by the program thread. Therefore, the most recent event to mutate and/or create the shared object 902 is causally consistent with the ongoing transaction. Since the most recent event to mutate and/or create the shared object 902 is causally consistent with the ongoing transaction, the program thread concludes that this event does not conflict with the accesses to the shared object 902 that are being attempted by the program operations. Based on this conclusion, the load barrier directs the program thread to create the transaction clone 912 of the shared object 902. The program thread creates the transaction clone 912 by copying the shared object 902 into the transaction area 910. After creating the transaction clone 912, the program thread is permitted to manipulate the transaction clone 912 rather than the shared object 902 while completing the program operations. While completing the program operations in this example, the program thread subsequently stores a new reference to an object field of the transaction clone 912, and the new reference points to the local address of private object 926 within the local area 920.

In an example embodiment, the program thread acquires a lock on the shared object 902, and the program thread performs an additional concurrency check on the shared object 902 while holding the lock (Operation 911). The program thread acquires the lock and performs the additional concurrency check while executing a barrier that is imposed on the program thread at the tail end of the ongoing transaction (hereafter “the commit barrier”). The commit barrier is imposed on the program thread after the program thread has completed the program operations. In other words, the program thread executes the commit barrier after the program thread has finished manipulating the transaction clones. The commit barrier instructs the program thread to check for potentially conflicting reads from the shared object 902 by accessing the read counter of the shared object 902. In this example, the read counter of the shared object 902 still records a value of zero at this point in the ongoing transaction. Thus, the program thread may conclude that there are no indirect reads from the shared object 902 that potentially conflict with committing the ongoing transaction. The commit barrier further instructs the program thread to check for conflicting mutations to the shared object 902 by comparing (a) the partial ordering of events that have been observed by the program thread leading up to the ongoing transaction to (b) the most recent event to mutate and/or create the shared object 902. For the purposes of this example, assume that the most recent event to mutate and/or create the shared object 902 is unchanged from when the program thread previously checked for conflicting mutations to the shared object 902 in Operation 907. Thus, the program thread concludes that the most recent event to mutate and/or create the shared object 902 does not conflict with the program operations targeting the shared object 902. Note that while holding the lock on the shared object 902, the program thread can assume that no other thread will be able to read from and/or write to the shared object 902. For the purposes of this example, further assume that no other shared object will be mutated by committing the ongoing transaction. In view of the foregoing, the program thread may conclude that it is safe to commit the ongoing transaction because the additional checks performed in this example operation have not revealed any potential source of a concurrency issue. Accordingly, the commit barrier directs the program thread to commit the ongoing transaction.

In an example embodiment, the program thread updates the state of private object 924 to match the mutated state of the transaction clone 914 while committing the ongoing transaction (Operation 913). The program thread synchronizes the state of the private object 924 with the state of the transaction clone 914 while executing the commit barrier. As noted above, mutating a private object typically poses no risk of creating a data race because a private object is generally accessible to a program instance through a single thread.

In an example embodiment, the program thread updates the state of the shared object 902 to match the mutated state of the transaction clone 912 while committing the ongoing transaction, and the program thread determines that this update renders private object 926 into another shared object (Operation 915). The program thread synchronizes the state of the shared object 902 with the mutated state of the transaction clone 912 while executing the commit barrier and while still holding the lock on the shared object 902. In addition to updating the state of the shared object 902, the commit barrier instructs the program thread to compare the mutated state of the shared object 902 to the former state of the shared object 902. The commit barrier instructs the program thread to perform this comparison to determine if any private objects should be promoted as a result of the state of the shared object 902 being mutated. As noted above, the program thread previously stored a new reference to an object field of transaction clone 912 while performing a program operation, and the new reference points to private object 926. Therefore, after the state of shared object 902 is synchronized with the mutated state of transaction clone 912, the shared object 902 will also include the new reference to private object 926. Accordingly, any thread that can reach shared object 902 will also be able to reach private object 926 once the ongoing transaction is completed (i.e., private object 926 will be rendered into another shared object). In an alternative example, the program thread determines that the private object 926 will be rendered into another shared object while executing a store barrier that is imposed on the program thread in response to the program operation that requests the storing of the new reference to the shared object 902.

In an example embodiment, the program thread promotes the private object 926 to the global area 900 in response to determining that the private object 926 is rendered into another shared object by the ongoing transaction (Operation 917). The program thread promotes the private object 926 to the global area 900 while executing the commit barrier. The program thread promotes the private object 926 to the global area 900 by creating promoted object 906. The promoted object 906 is a copy of private object 926 that is stored to the global area 900 by the program thread. After creating promoted object 906, the commit barrier may further instruct the program thread to remap the new reference in the shared object 902 to the global address of promoted object 906. Alternatively, the remapping of the new reference stored to shared object 902 may be completed lazily pursuant to another barrier that is imposed on the program thread if and when the program thread subsequently attempts to load the new reference in shared object 902 at the behest of the program instance. Note that there may be other stale references to the local address of private object 926 that persist after the ongoing transaction is completed. For instance, private object 924 might retain a stale reference to the local address of private object 926 after the ongoing transaction is completed. Any stale reference to the local address of private object 926 that remains after the ongoing transaction is completed may be lazily remapped to the global address of promoted object 906. A stale reference to the local address of private object 926 may be lazily remapped by a thread pursuant to a load barrier that is imposed on the thread if and when the thread attempts to load that stale reference. After the ongoing transaction is completed, private object 926 may remain reachable through stale references to the local address of private object 926. Accordingly, private object 926 may still be a live object after the ongoing transaction is completed. However, private object 926 is effectively no longer accessible to a program instance at this point in the ongoing transaction because any subsequent attempt to load a stale reference to the local address of private object 926 will be met with an intervening load barrier that remaps that stale reference to the global address of promoted object 906.

In an example embodiment, the program thread releases the lock on the shared object 902, and the program thread discards any transaction clones that are still live at this point in the ongoing transaction (Operation 919). The program thread releases the lock on the shared object 902 while executing the commit barrier. After releasing the lock on shared object 902, the program thread may conclude that the ongoing transaction has been successfully completed. The program thread may subsequently discard transaction clone 912 and/or transaction clone 914 if these transaction clones have not already been discarded by the program thread, and the memory space occupied by transaction area 910 may be reclaimed.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

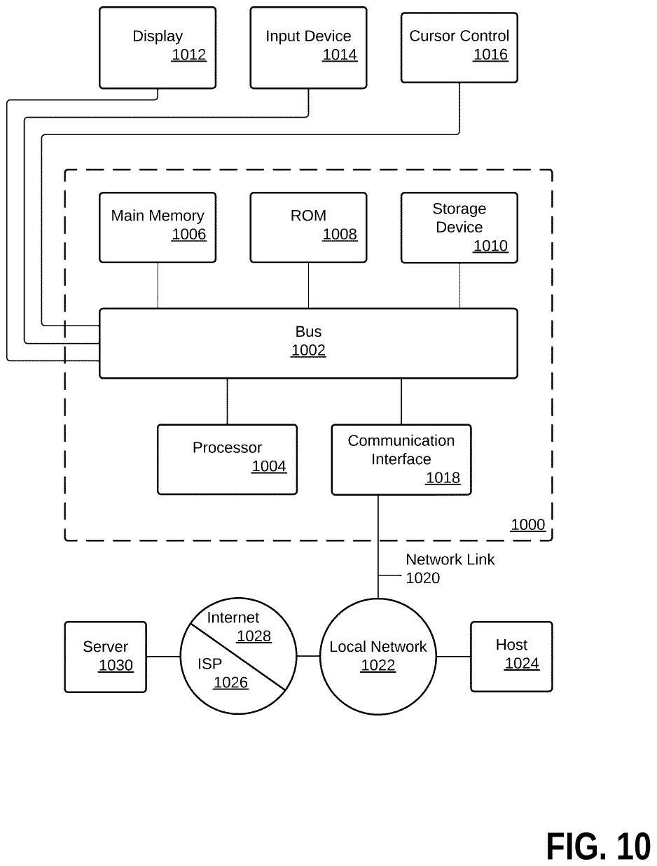

For example, FIG. 10 is a block diagram that illustrates a computer system 1000 upon which an embodiment of the disclosure may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media comprising instructions that, when executed by one or more hardware processors, cause performance of operations comprising:
responsive to a request to perform a program task that is attempting to apply a modification to a shared data structure that is comprised within a global area of runtime memory that is accessible to a plurality of threads:
generating a copy of the shared data structure in a transaction area of runtime memory that is allocated for performing the program task through a software memory transaction;
applying the modification to the copy of the shared data structure that is comprised within the transaction area of runtime memory;
subsequent to acquiring a lock on the shared data structure that is comprised within the global area of runtime memory: performing a check for other accesses to the shared data structure that potentially conflict with mutating the shared data structure through the software memory transaction; and
performing one of:
(a) based, at least in part, on determining that there is no access to the shared data structure that potentially conflicts with mutating the shared data structure through the software memory transaction: updating the shared data structure that is comprised within in the global area of runtime memory to match a mutated state of the copy of the shared data structure that is comprised within in the transaction area of runtime memory; or
(a) based, at least in part, on determining that there is another access to the shared data structure that potentially conflicts with mutating the shared data structure through the software memory transaction: aborting the software memory transaction.

2. The one or more non-transitory computer readable media of claim 1:
wherein shared data structures are organized into the global area of runtime memory by a thread-local garbage collector;
wherein the thread-local garbage collector organizes private data structures into a plurality of private areas of runtime memory that respectively correspond to the plurality of threads; and
wherein performing the check for other accesses to the shared data structure that potentially conflict with mutating the shared data structure through the software memory transaction comprises: checking for other accesses that are causally inconsistent with mutating the shared data structure through the software memory transaction.

3. The one or more non-transitory computer-readable media of claim 1, wherein the operations further comprise:
prior to acquiring the lock on the shared data structure that is comprised within in the global area of runtime memory:
performing an initial check for other accesses to the shared data structure that potentially conflict with mutating the shared data structure through the software memory transaction,
wherein the initial check for concurrent accesses to the shared data structure fails to reveal (a) one or more accesses to the shared data structure that potentially conflict with mutating the shared data structure through the software memory transaction or (b) a causality bug in a program instance comprising the request to perform the program task.

4. The one or more non-transitory computer-readable media of claim 3, wherein generating the copy of the shared data structure in the transaction area of runtime memory that is allocated for performing the program task through the software memory transaction is responsive to the initial check for other accesses to the shared data structure that potentially conflict with mutating the shared data structure through the software memory transaction failing to reveal (a) one or more accesses to the shared data structure that potentially conflict with mutating the shared data structure through the software memory transaction or (b) the causality bug in the program instance that comprises the request to perform the program task.

5. The one or more non-transitory computer-readable media of claim 1:
wherein performing the check for other accesses to the shared data structure that potentially conflict with mutating the shared data structure through the software memory transaction comprises: determining if a most recent event to mutate and/or create the shared data structure is included in a partial ordering of events that led up to the software memory transaction;
wherein determining that there is no access to the shared data structure that potentially conflicts with mutating the shared data structure through the software memory transaction comprises: determining that the most recent event to mutate and/or create the shared data structure is comprised within the partial ordering of events that led up to the software memory transaction; and
wherein determining that there is another access to the shared data structure that potentially conflicts with mutating the shared data structure through the software memory transaction comprises: determining that the most recent event to mutate and/or create the shared data structure is not comprised within the partial ordering of events that led up to the software memory transaction.

6. The one or more non-transitory computer-readable media of claim 5, wherein determining if the most recent event to mutate and/or create the shared data structure is included in the partial ordering of events that led up to the software memory transaction comprises:
comparing a first event object representing the most recent event to mutate and/or create the shared data structure to a chain of event objects that represent the partial ordering of events that led up to the software memory transaction.

7. The one or more non-transitory computer-readable media of claim 5:
wherein performing the check for other accesses to the shared data structure that potentially conflict with mutating the shared data structure through the software memory transaction comprises: determining that the most recent event to mutate and/or create the shared data structure is comprised within the partial ordering of events that led up to the software memory transaction; and
wherein the operations further comprise:
responsive to updating the shared data structure that is comprised within the global area of runtime memory to match the mutated state of the copy of the shared data structure that is comprised within the transaction area of runtime memory:
updating an indicator of the most recent event to mutate and/or create the shared data structure to refer to a new event corresponding to performing the program task through the software memory transaction.

8. The one or more non-transitory computer-readable media of claim 1:
wherein the copy of the shared data structure is generated in the transaction area by a thread while executing a first barrier that is imposed on the thread during the software memory transaction;
wherein the first barrier is imposed on the thread in response to an operation targeting the shared data structure that is defined in instructions for completing the program task;
wherein the modification to the shared data structure is defined in the instructions for completing the program task; and
wherein the thread performs the check for other accesses to the shared data structure that potentially conflict with mutating the shared data structure through the software memory transaction while executing a second barrier that is imposed on the thread during the software memory transaction.

9. The one or more non-transitory computer-readable media of claim 1:
wherein the shared data structure that is comprised within the global area of runtime memory is at least one of: (a) stored in non-volatile memory or (b) occupies less memory space than the copy of the shared data structure that is comprised within the transaction area of runtime memory; and
wherein the copy of the shared data structure that is comprised within the transaction area of runtime memory is at least one of: (a) stored in volatile memory or (b) occupies more memory space than the shared data structure that is comprised within the global area of runtime memory.

10. The one or more non-transitory computer-readable media of claim 1:
wherein performing the check for other accesses to the shared data structure that potentially conflict with mutating the shared data structure through the software memory transaction comprises: determining that there is no access to the shared data structure that potentially conflicts with mutating the shared data structure through the software memory transaction; and
wherein the operations further comprise:
prior to updating the shared data structure to match the mutated state of the copy of the shared data structure:
generating a second copy of the shared data structure in a second transaction area of runtime memory that is allocated for performing a second program task through a second software memory transaction; and
subsequent to updating the shared data structure that is comprised within the global area of runtime memory to match the mutated state of the copy of the shared data structure that is comprised within the transaction area of runtime memory:
responsive to determining that the program task mutates the shared data structure while the second program task is being performed concurrently through the second software memory transaction: aborting the second software memory transaction.

11. The one or more non-transitory computer-readable media of claim 1:
wherein the shared data structure that is comprised within the global area of runtime memory is a shared object;
wherein the copy of the shared data structure that is comprised within the transaction area of runtime memory is a transaction clone of the shared object;
wherein applying the modification to the copy of the shared data structure that is comprised within the transaction area of runtime memory comprises: storing, by a thread to the transaction clone of the shared object, a first reference that points to a runtime object;
wherein the runtime object is comprised within a local area of runtime memory that is allocated, at least in part, for private objects of the thread;
wherein performing the check for other accesses to the shared data structure that potentially conflict with mutating the shared data structure through the software memory transaction comprises: determining that there is no access to the shared data structure that potentially conflicts with mutating the shared data structure through the software memory transaction; and
wherein the operations further comprise:
generating, by the thread in the global area of runtime memory, a copy of the runtime object; and
storing, by the thread to the shared object, a second reference to the copy of the runtime object that is comprised within the global area of runtime memory.

12. A method comprising:
responsive to a request to perform a program task that is attempting to apply a modification to a shared data structure that is comprised within a global area of runtime memory that is accessible to a plurality of threads:
generating a copy of the shared data structure in a transaction area of runtime memory that is allocated for performing the program task through a software memory transaction;
applying the modification to the copy of the shared data structure that is comprised within the transaction area of runtime memory;
subsequent to acquiring a lock on the shared data structure that is comprised within the global area of runtime memory: performing a check for other accesses to the shared data structure that potentially conflict with mutating the shared data structure through the software memory transaction; and
performing one of:
(a) based, at least in part, on determining that there is no access to the shared data structure that potentially conflicts with mutating the shared data structure through the software memory transaction: updating the shared data structure that is comprised within in the global area of runtime memory to match a mutated state of the copy of the shared data structure that is comprised within in the transaction area of runtime memory; or
(a) based, at least in part, on determining that there is another access to the shared data structure that potentially conflicts with mutating the shared data structure through the software memory transaction: aborting the software memory transaction,
wherein the method is performed by at least one device including a hardware processor.

13. The method of claim 12:
wherein shared data structures are organized into the global area of runtime memory by a thread-local garbage collector;
wherein the thread-local garbage collector organizes private data structures into a plurality of private areas of runtime memory that respectively correspond to the plurality of threads; and
wherein performing the check for other accesses to the shared data structure that potentially conflict with mutating the shared data structure through the software memory transaction comprises: checking for other accesses that are causally inconsistent with mutating the shared data structure through the software memory transaction.

14. The method of claim 12, further comprising:
prior to acquiring the lock on the shared data structure that is comprised within in the global area of runtime memory:
performing an initial check for other accesses to the shared data structure that potentially conflict with mutating the shared data structure through the software memory transaction,
wherein the initial check for concurrent accesses to the shared data structure fails to reveal (a) one or more accesses to the shared data structure that potentially conflict with mutating the shared data structure through the software memory transaction or (b) a causality bug in a program instance comprising the request to perform the program task.

15. The method of claim 12:
wherein performing the check for other accesses to the shared data structure that potentially conflict with mutating the shared data structure through the software memory transaction comprises: determining if a most recent event to mutate and/or create the shared data structure is included in a partial ordering of events that led up to the software memory transaction;
wherein determining that there is no access to the shared data structure that potentially conflicts with mutating the shared data structure through the software memory transaction comprises: determining that the most recent event to mutate and/or create the shared data structure is comprised within the partial ordering of events that led up to the software memory transaction; and
wherein determining that there is another access to the shared data structure that potentially conflicts with mutating the shared data structure through the software memory transaction comprises: determining that the most recent event to mutate and/or create the shared data structure is not comprised within the partial ordering of events that led up to the software memory transaction.

16. The method of claim 12:
wherein the copy of the shared data structure is generated in the transaction area by a thread while executing a first barrier that is imposed on the thread during the software memory transaction;
wherein the first barrier is imposed on the thread in response to an operation targeting the shared data structure that is defined in instructions for completing the program task;
wherein the modification to the shared data structure is defined in the instructions for completing the program task; and
wherein the thread performs the check for other accesses to the shared data structure that potentially conflict with mutating the shared data structure through the software memory transaction while executing a second barrier that is imposed on the thread during the software memory transaction.

17. The method of claim 12:
wherein the shared data structure that is comprised within the global area of runtime memory is at least one of: (a) stored in non-volatile memory or (b) occupies less memory space than the copy of the shared data structure that is comprised within the transaction area of runtime memory; and
wherein the copy of the shared data structure that is comprised within the transaction area of runtime memory is at least one of: (a) stored in volatile memory or (b) occupies more memory space than the shared data structure that is comprised within the global area of runtime memory.

18. A system comprising:
at least one device including a hardware processor;
the system being configured to perform operations comprising:
responsive to a request to perform a program task that is attempting to apply a modification to a shared data structure that is comprised within a global area of runtime memory that is accessible to a plurality of threads:
generating a copy of the shared data structure in a transaction area of runtime memory that is allocated for performing the program task through a software memory transaction;
applying the modification to the copy of the shared data structure that is comprised within the transaction area of runtime memory;
subsequent to acquiring a lock on the shared data structure that is comprised within the global area of runtime memory: performing a check for other accesses to the shared data structure that potentially conflict with mutating the shared data structure through the software memory transaction; and
performing one of:
(a) based, at least in part, on determining that there is no access to the shared data structure that potentially conflicts with mutating the shared data structure through the software memory transaction: updating the shared data structure that is comprised within in the global area of runtime memory to match a mutated state of the copy of the shared data structure that is comprised within in the transaction area of runtime memory; or
(a) based, at least in part, on determining that there is another access to the shared data structure that potentially conflicts with mutating the shared data structure through the software memory transaction: aborting the software memory transaction.

19. The system of claim 18:
wherein shared data structures are organized into the global area of runtime memory by a thread-local garbage collector;
wherein the thread-local garbage collector organizes private data structures into a plurality of private areas of runtime memory that respectively correspond to the plurality of threads; and
wherein performing the check for other accesses to the shared data structure that potentially conflict with mutating the shared data structure through the software memory transaction comprises: checking for other accesses that are causally inconsistent with mutating the shared data structure through the software memory transaction.

20. The system of claim 18, wherein the operations further comprise:
prior to acquiring the lock on the shared data structure that is comprised within in the global area of runtime memory:
performing an initial check for other accesses to the shared data structure that potentially conflict with mutating the shared data structure through the software memory transaction,
wherein the initial check for concurrent accesses to the shared data structure fails to reveal (a) one or more accesses to the shared data structure that potentially conflict with mutating the shared data structure through the software memory transaction or (b) a causality bug in a program instance comprising the request to perform the program task.
